(19) United States
(12) Patent Application Publication
(10) Pub. No.: US 2023/0186262 A1
(43) Pub. Date: Jun. 15, 2023

(54) Systems, Methods, and Apparatus that Provide Immutable and Expandable NFTs Stored Completely On a Blockchain

(71) Applicant: James David Busch, Tempe, AZ (US)

(72) Inventor: James David Busch, Tempe, AZ (US)

(21) Appl. No.: 17/945,076

(22) Filed: Sep. 14, 2022

Related U.S. Application Data
(60) Provisional application No. 63/243,750, filed on Sep. 14, 2021.

(51) Int. Cl. G06Q 20/12; G06Q 20/38

(52) U.S. Cl. CPC G06Q 20/123; G06Q 20/3827; G06Q 2220/00

(57) ABSTRACT

Current Non-Fungible Tokens (NFTs) rely on numerous legacy systems that can be altered or fail. The disclosed devices, methods and systems, present technical solutions to this problem which improves the functionality of NFT systems by storing all relevant information in a blockchain. A NFT may be created that is associated with a Page. An author/owner of the Page may insert Posts by calling a function on a smart contract that created the NFT. The Post is verified as coming from the owner of the Page and is placed into a logging or storage portion of a blockchain. People wishing to view the NFT may pull the logs or storage for the smart contract and obtain all content associated with that Page and optional Tag. Commands may also be placed in the Content to further modify the Page or organize the information. Posts can be used as building blocks.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### CROSS REFERENCE TO RELATED APPLICATIONS

This application claims the benefit of U.S. Provisional Application Ser. No. 63/243,750 filed Sep. 14, 2021, which is herein incorporated by reference in its entirety.

### REFERENCE TO A “SEQUENCE LISTING,” A TABLE, OR A COMPUTER PROGRAM LISTING APPENDIX SUBMITTED AS AN ASCII TEXT FILE

The official copy of the computer program listing appendix is submitted as an ASCII formatted text file via EFS-Web, with a file name of “IMMUTABLES_CODE_LISTING.txt”, a creation date of Sep. 14, 2022, and a size of 84956 bytes. The computer program listing filed via EFS-Web is part of the specification, is incorporated in its entirety by reference herein. Portions of this computer program listing appendix are also available on the Main Ethereum Blockchain at the following locations:
0x499f4943fB86717adcE584927E6AB5a172f03001
0x4a982a67312a34ef2a0047e730b58f1de05e92b1
0xA8A6CB3978e2c4EdcF5A3d0cB3400E1E5D031479
0x5e61ec18781ef933460c7ec80f36c996e023e458
   The code stored at these listings are similarly part of the specification, is incorporated in its entirety by reference herein.

### BACKGROUND

### 1. Field of the Invention

This disclosure generally relates to methods and systems that implement Non-Fungible Tokens (NFTs) on blockchains. Numerous additional applications and features are also discussed herein. For example, this disclosure more specifically relates to storing the NFT data on-chain in a way that is cryptographically verified to come from the creator of the content, and prevent later modification.

Traditional NFTs are merely pointers to a location on the internet. A smart contract usually just stores a mapping of a number (1,2,3 . . . ) to an owner's address. The smart contract then provides a URL corresponding to the number. The actual work associated with the “NFT”—what people think they are getting—is disassociated with the smart contract via several layers of JSON Metadata and Web servers.

Like shortened internet ULR links, these pointers can erode over time and eventually point to either incorrect information, or nothing at all. With many points of failure, these traditional NFTs can be very fragile over time, and eventually holders of these NFTs may become disappointed when their NFTs no longer reference the expected information.

To solve this problem, NFT's should directly contain the content they purport to convey.

In that regard, some NFTs have been written “fully on-chain” such the smart contract code provides a full response including metadata and a Scalable Vector Graphics (SVG) image in response to a request for a token. This, however, is inflexible and can be expensive. The limited Ethereum Virtual Machine, or similar machine on other blockchains, must run the code to generate the image so the capabilities of the NFT are limited.

Accordingly, NFT's should not only contain the information that they purport to convey, but they should do it in an efficient and flexible manner.

To solve this problem, this disclosure discusses an NFT smart contract that creates a Page (alternatively referred to as a Namespace) associated with the NFT. Then, Posts can be made “into the Page. These Posts can contain content that is logged into the Page using the Ethereum smart contract logging system (or alternatively contract storage at higher Ethereum gas usage). These posts have verified authorship based on the Poster's Ethereum wallet address, contain the actual content to be associated with the NFT, cannot be changed, and cannot be removed. A viewer of the NFT can obtain the Page name and look at the logs for all content logged into the smart contract for that Page. The smart contract can enforce a rule that only the owner of the NFT can log information into the Page. Each Post is assigned a transaction hash by the blockchain system. These Pages are Non-Fungible Tokens.

Furthermore, the Posts within the pages can be the basis for additional on-chain content. As an example, a Post within a Page can be referenced by other decentralized applications by its transaction hash. If the Post contains executable code defining an artwork or game object, that post can be imported into another application by its transaction hash and executed. The code from the Post may form the basis for another on-chain NFT.

### Description of Related Art

So as to reduce the complexity and length of the Detailed Specification, and to fully establish the state of the art in certain areas of technology, Applicant(s) herein expressly incorporate(s) by reference all of the following materials identified in each numbered paragraph below.

For more information on hashing, see, for example: Cite Nos. D0046-D0047, and D0082. (Note that KECCAK256 is a variant of SHA-3 that uses 0x01 padding instead of 0x06.)

For more information on cryptography, encryption, and message signing, see, for example: Cite Nos. D0048-D0061, and D0075.

For more information on cryptocurrency and blockchain technology, see, for example: Cite Nos. D0062-D0072, and D0086-D0087.

For more information on smart contracts and non-fungible tokens, see, for example: Cite Nos. A0012, D0076-D0079, and D0090.

For more information on distributed file storage see, for example: Cite Nos. D0073, D0074.

For more information on web client development see, for example: Cite Nos. D0088 D0089.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY OF THE INVENTION

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts in defining the claimed invention. The inventor is fully aware that he can be his own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of post-AIA 35 U.S.C. § 112(f). Thus, the use of the words “function,” “means” or “step” in the Detailed Description or Description of the Drawings or claims is not intended to somehow indicate a desire to invoke the special provisions of post-AIA 35 U.S.C. § 112(f), to define the claimed invention. To the contrary, if the provisions of post-AIA 35 U.S.C. § 112(f) are sought to be invoked to define the claimed inventions, the claims will specifically and expressly state the exact phrases “means for” or “step for,” and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of post-AIA 35 U.S.C. § 112(f). Moreover, even if the provisions of post-AIA 35 U.S.C. § 112(f) are invoked to define the claimed inventions, it is intended that the claimed inventions not be limited only to the specific structure, material or acts that are described in the preferred embodiments, but in addition, include any and all structures, materials or acts that perform the claimed function as described in alternative embodiments or forms of the claimed invention, or that are well known present or later-developed, equivalent structures, material or acts for performing the claimed function.

The aspects, features, and advantages will be apparent to those artisans of ordinary skill in the art from the DETAILED DESCRIPTION and DRAWINGS, and from the CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1A depicts a typical “prior art” NFT system.

FIG. 1B depicts another “prior art” NFT system. that utilizes the interplanetary filesystem (IPFS) distributed filesystem to store metadata and other content.

FIG. 1C depicts a “fully on-chain” “prior art” NFT system. that utilizes a smart contract to define the NFT.

FIG. 2A depicts an example system and method of posting to and viewing from a tamper proof, immutable, and expandable on-chain NFT storage system.

FIG. 2B depicts an example system and method of minting a Page NFT.

FIG. 2C depicts an example system and method for a smart-contract based metadata server to provide support for legacy marketplaces.

FIG. 2D depicts an example system and method for a metadata server to provide support for legacy marketplaces.

FIG. 3A depicts an example user interface showing a Home overview tab of a platform information modal.

FIG. 3B depicts an example user interface showing a Pages explanation tab of a platform information modal.

FIG. 3C depicts an example user interface showing a Posts explanation tab of a platform information modal.

FIG. 3D depicts an example user interface showing a Tags explanation tab of a platform information modal.

FIG. 3E depicts an example user interface showing an On Chain explanation tab of a platform information modal.

FIG. 3F depicts an example user interface showing a Metadata explanation tab of a platform information modal.

FIG. 3G depicts an example user interface showing a mint a Page (or namespace) modal.

FIG. 3H depicts an example user interface showing an empty Page (or namespace).

FIG. 3I depicts an example user interface showing a compose a Post (or Immutable).

FIG. 3J depicts an example user interface showing an add on-chain image insertion tool tab of a compose a Post modal.

FIG. 3K depicts an example user interface showing an add IPFS image insertion tool tab of a compose a Post modal.

FIG. 3L depicts an example user interface showing a compose a Post modal including an on-chain image in the content of the draft post (left content pane is the code depicts right content pane is the preview).

FIG. 3M depicts an example user interface showing a Page including a Post.

FIG. 3N depicts an example user interface showing a Page including a Post with the Post details footer expanded.

FIG. 3O depicts an example Etherscan Overview user interface showing the Post depicted in FIG. 3M inserted on the blockchain.

FIG. 3P depicts an example Etherscan Logs user interface showing the Post depicted in FIG. 3M inserted on the blockchain.

FIG. 3Q depicts an example user interface showing a compose a Post modal configured to reply to a prior Post.

FIG. 3R depicts an example user interface showing a Page and Post that includes a Reply.

FIG. 3S depicts an example user interface showing a Post that is a Reply to a another Post.

FIG. 3T depicts an example user interface showing a Page (or Namespace) navigation tool.

FIG. 3U depicts an example user interface showing Pages associated with an account.

FIG. 3V depicts an example user interface showing new Posts.

FIG. 3W depicts an example user interface showing new Pages (or Namespaces).

FIG. 3X depicts an example user interface showing optional filters to apply to Posts.

FIG. 3Y depicts an example user interface showing a metadata server configuration option in an administrative modal.

FIG. 3Z depicts an example user interface showing a user fees configuration form in an administrative modal.

FIG. 3AA depicts an example user interface showing a beneficiary form in an administrative modal.

FIG. 3BB depicts an example user interface showing a withdraw tab of an administrative modal.

FIG. 3CC depicts an example user interface showing Page details.

FIG. 3DD depicts an example user interface showing a compose a Post (or immutable) including a Tag specifying “image” and Content including an image file.

FIG. 4A depicts an example OpenSea marketplace user interface showing an overview of different Pages that have been minted.

FIG. 4B depicts an example OpenSea marketplace user interface showing details about a particular Page NFT.

FIG. 5A depicts an example user interface showing a Page NFT including an on-chain image, a markdown text post depicts and a higher resolution IPFS image.

FIG. 5B depicts an example user interface showing a Post including an IPFS image.

FIG. 5C depicts an example user interface showing a Post including an on-chain image with the Post details table expanded.

FIG. 5D depicts an example Etherscan Overview user interface showing the on-chain image inserted into the blockchain.

FIG. 5E depicts an example Etherscan Logs user interface showing the on-chain image inserted into the blockchain.

FIG. 5F depicts an example user interface showing a Post including an IPFS image with the Post details table expanded.

FIG. 5G depicts an example Etherscan Overview user interface showing the IPFS image inserted into the blockchain.

FIG. 5H depicts an example Etherscan Logs user interface showing the IPFS image inserted into the blockchain.

FIG. 5I depicts an example user interface showing a Page with multiple Posts including a post with on-chain image.

FIG. 5J depicts an example Etherscan Overview user interface relating to the Post illustrated in FIG. 51 was inserted into the blockchain.

FIG. 5K depicts an example Etherscan Logs user interface relating to the Post illustrated in FIG. 5I was inserted into the blockchain.

FIG. 6A depicts an example system and method of creating a generative art project that reference code stored in Post transaction.

FIG. 6B depicts an example system and method of purchasing an edition of an art project.

FIG. 6C depicts an example system and method of viewing an edition of a generative art project.

FIG. 6D depicts an example system and method for a metadata server to provide support for legacy marketplaces.

FIG. 7A depicts an example user interface showing a Page with generative art project information in one Post depicts and generative art code in a second Post.

FIG. 7B depicts an example user interface showing information about creating a project on the generative art platform when the viewer does not have permission to create a project.

FIG. 7C depicts an example user interface showing information about creating a project on the generative art platform when the viewer does have permission to create a project.

FIG. 7D depicts an example user interface showing the create a project form.

FIG. 7E depicts an example user interface to mint an edition of a project.

FIG. 7F depicts an example user interface showing an overview grid view of many editions of a generative art project.

FIG. 7G depicts an example user interface showing an active projects tab of a platform information menu.

FIG. 7H depicts an example user interface showing an artist's royalty information tab of a platform information menu.

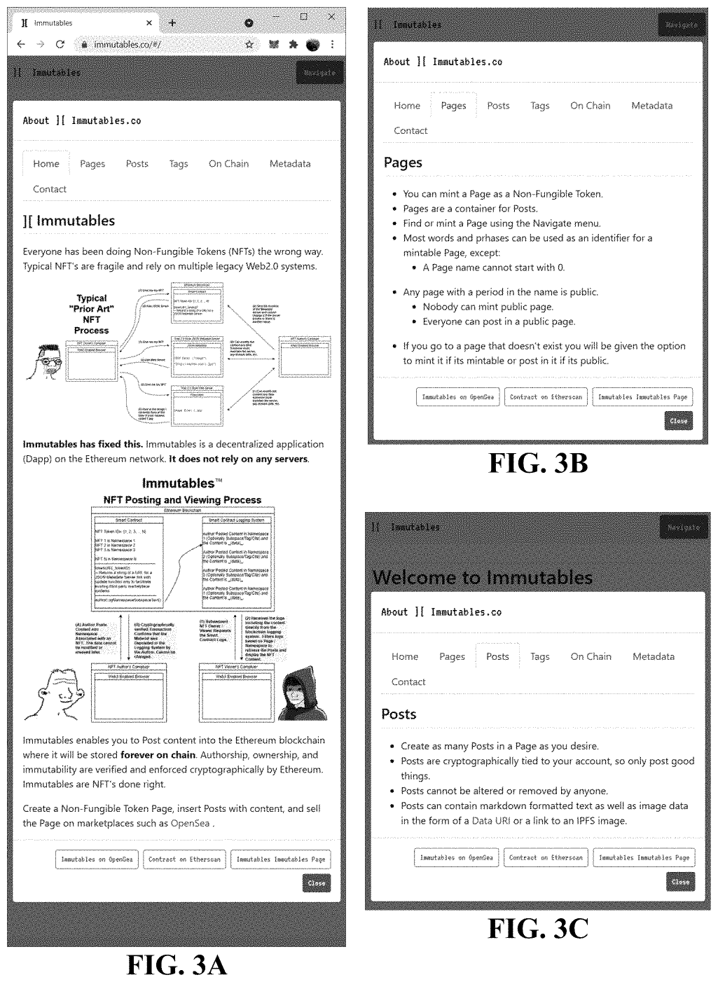

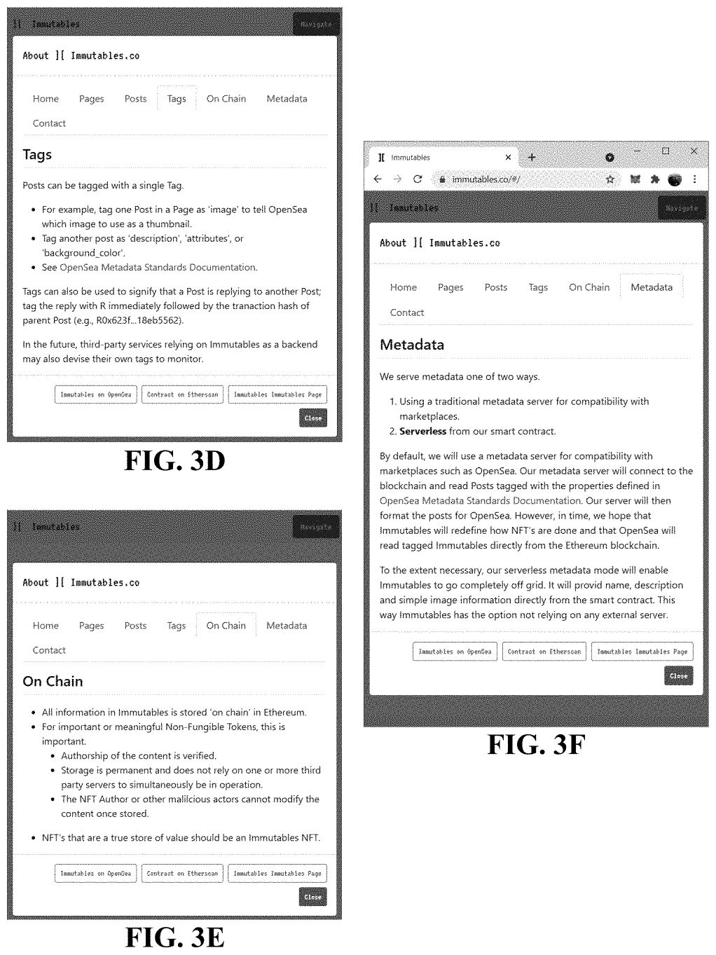

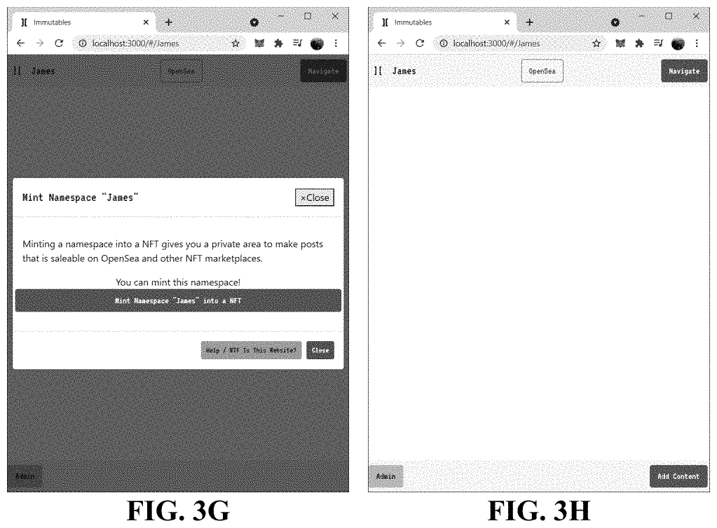

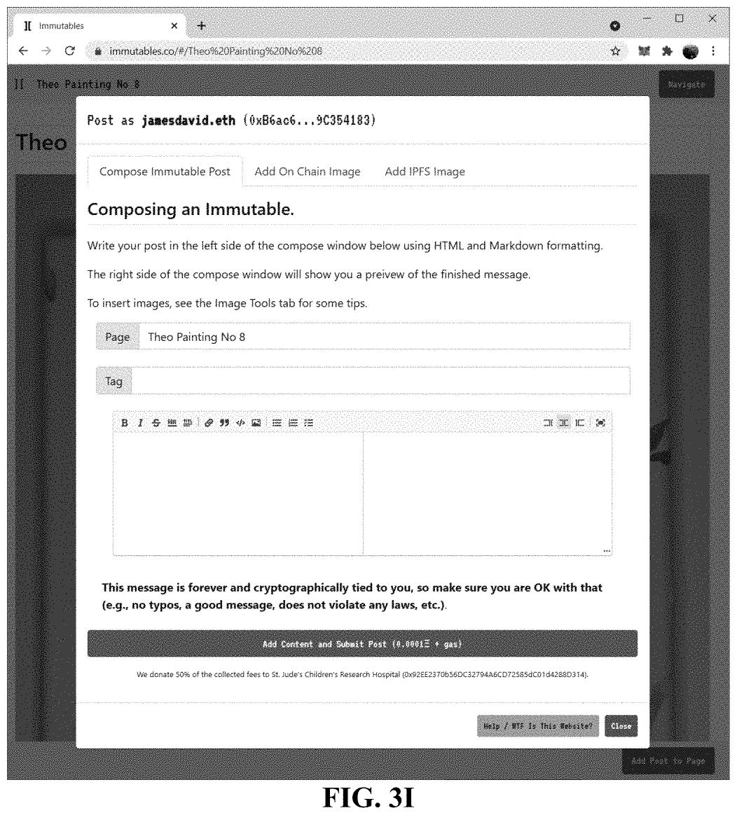

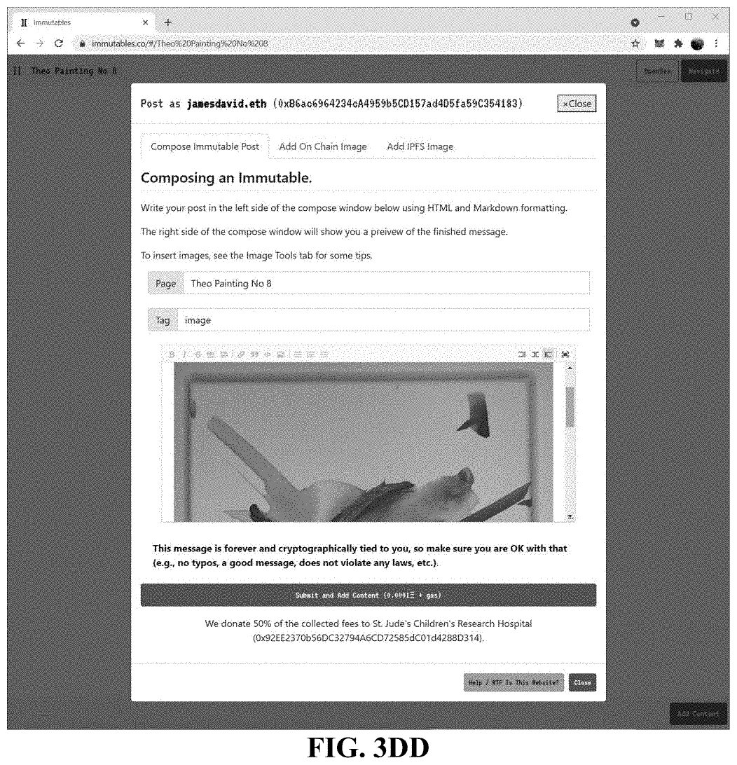

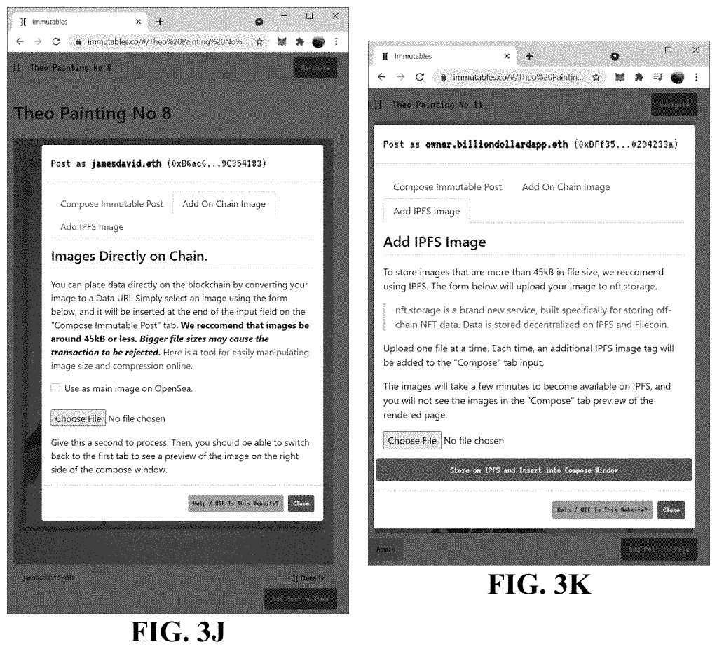

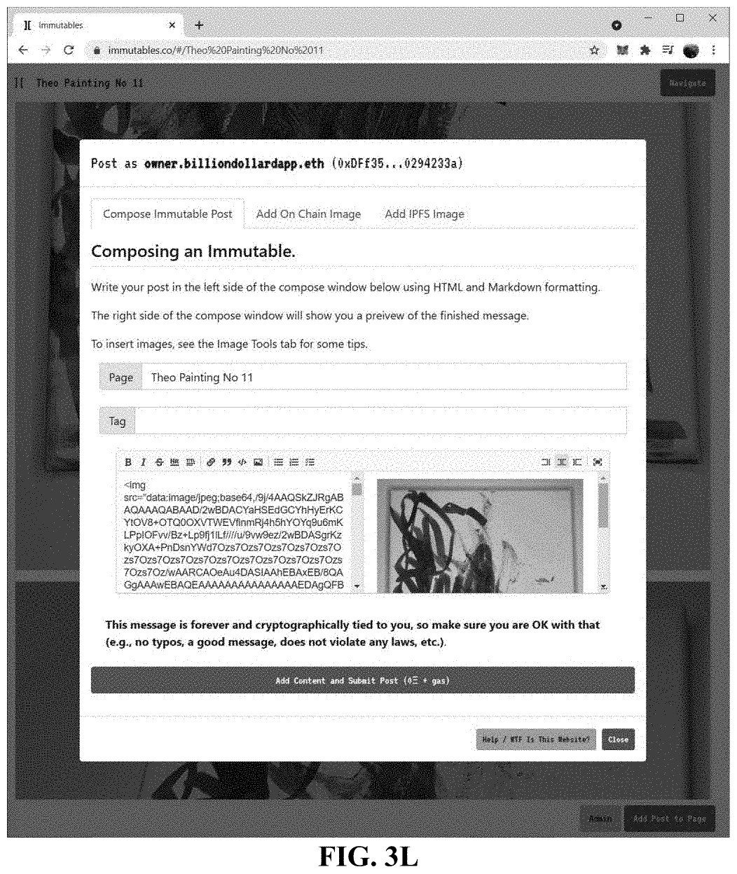

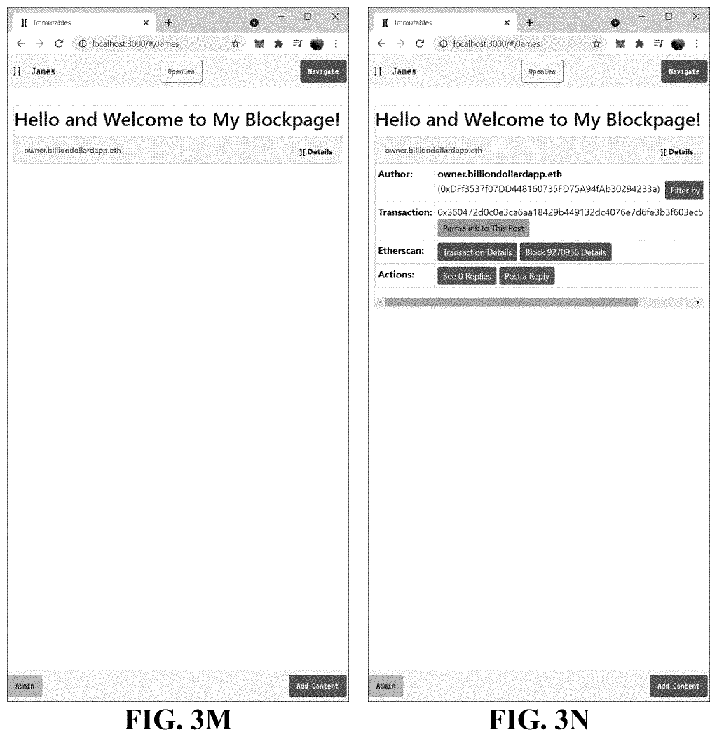

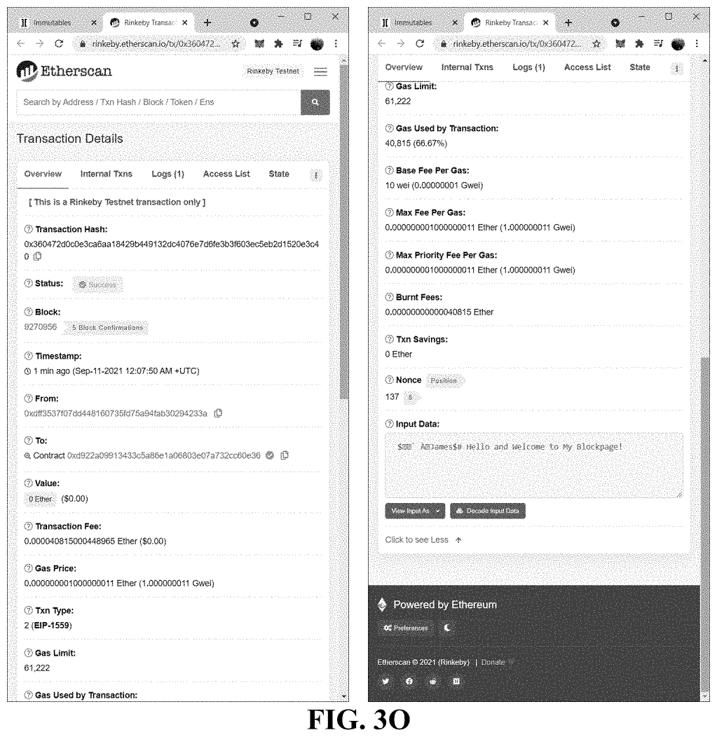

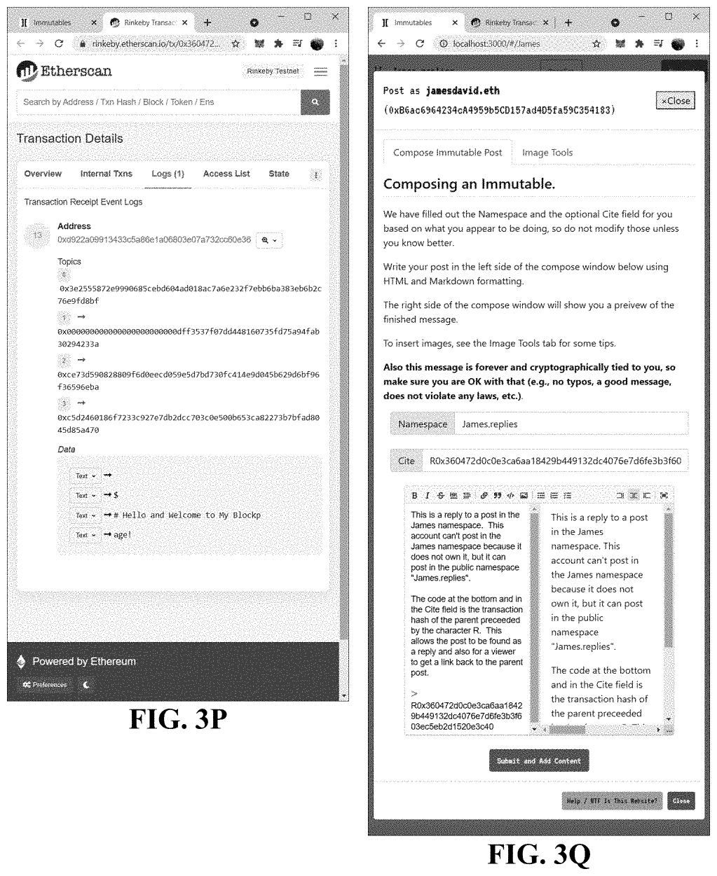

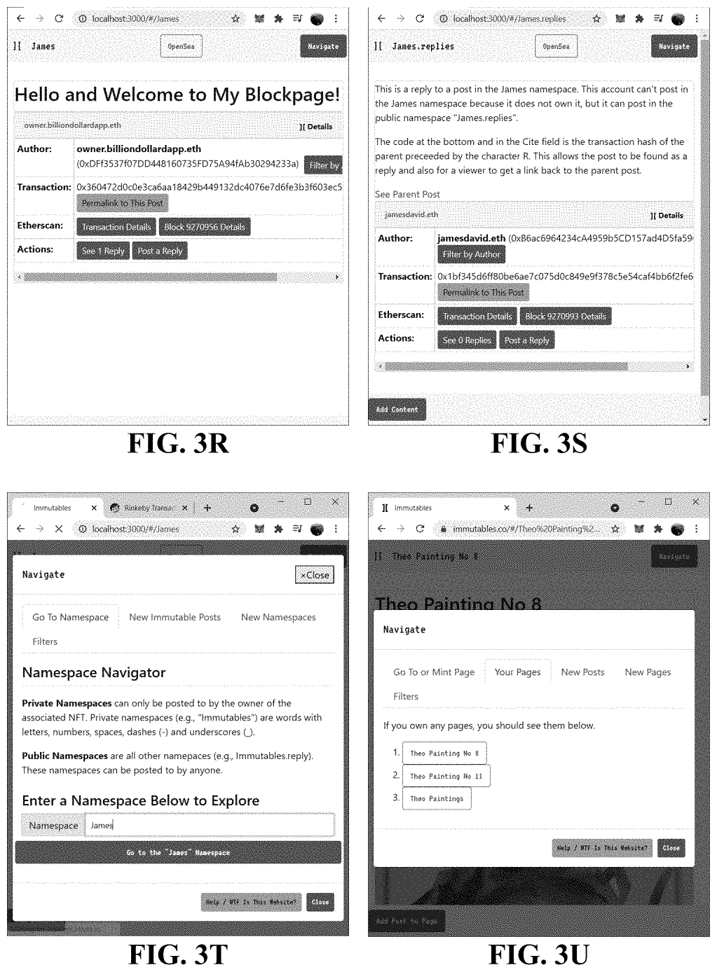

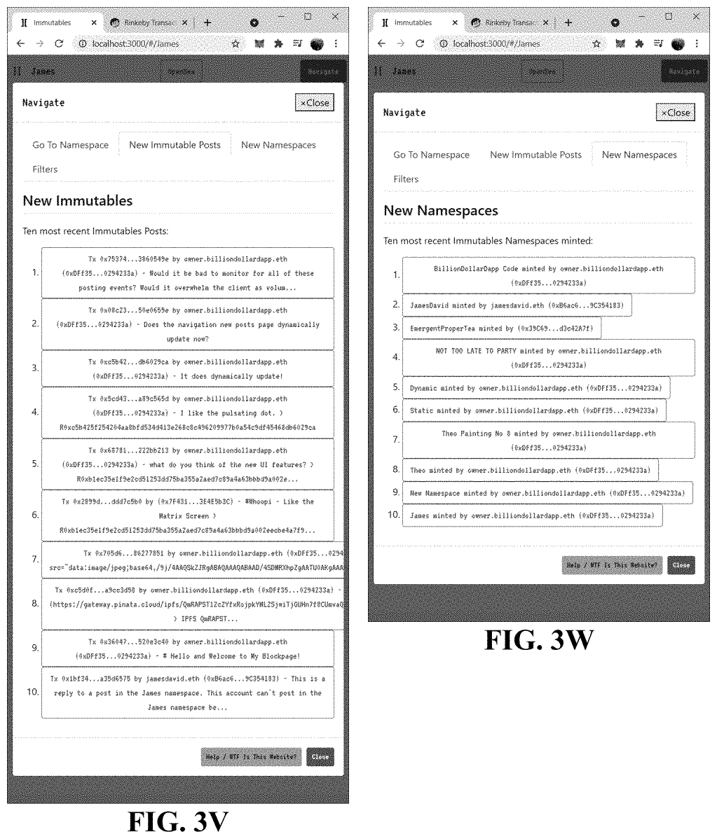

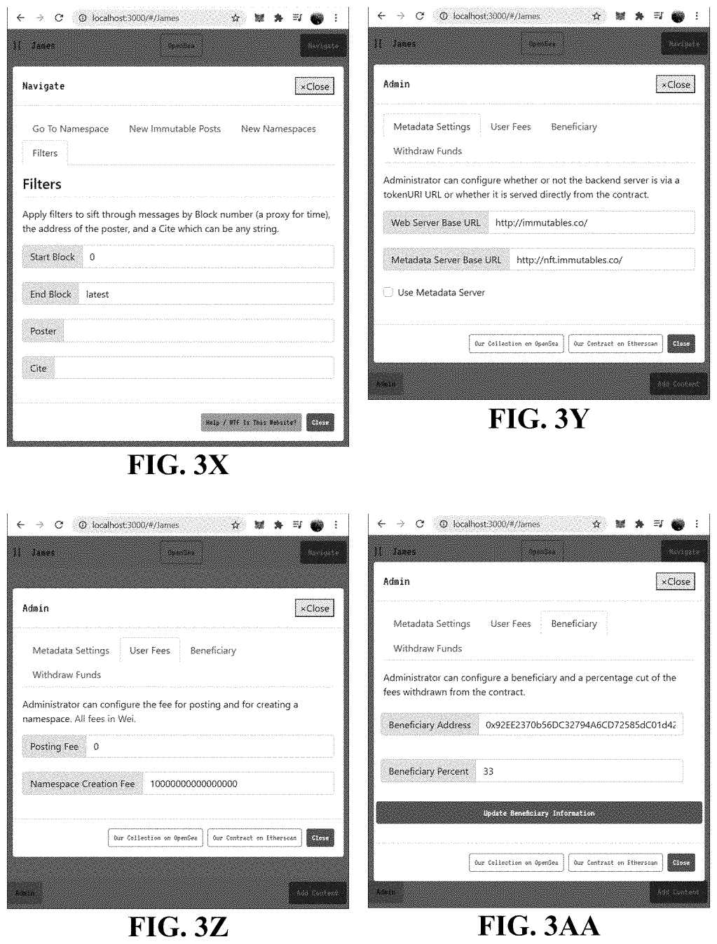

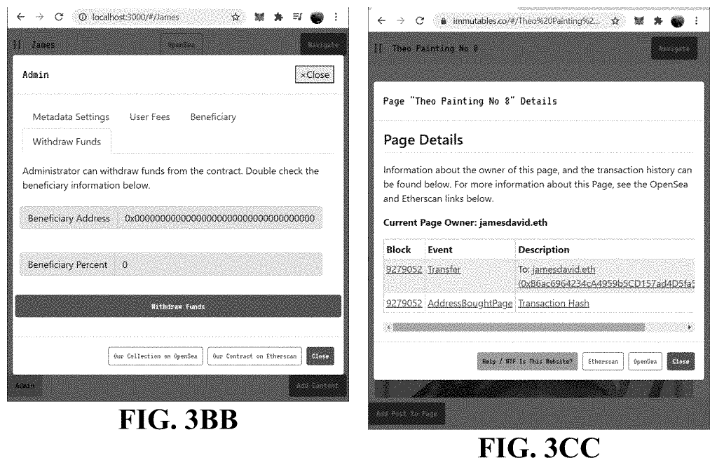

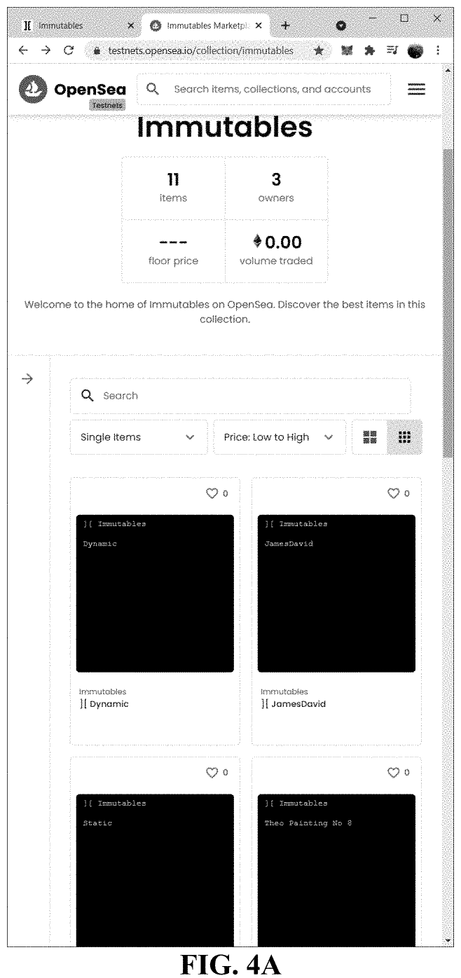

FIG. 3I depicts an example user interface showing users information about clearing their local storage browser cache depicts used to store information from the blockchain,.

FIG. 8A depicts an example user interface showing the basic information tab of a project administration form.

FIG. 8B depicts an example user interface showing the project category tab of a project administration form.

FIG. 8C depicts an example user interface showing a source code tab of a project administration form.

FIG. 8D depicts an example user interface showing an additional payee tab of a project administration form.

FIG. 8E depicts an example user interface showing an artist address tab of a project administration form.

FIG. 8F depicts an example user interface showing a royalties tab of a project administration form.

FIG. 8G depicts an example user interface showing a token data export tab of a project administration form.

FIG. 8H depicts an example user interface showing a metadata IPFS Thumbnails tab of a project administration form.

FIG. 8I depicts an example user interface showing a User Interface CSS override tab of a project administration form.

FIG. 9A depicts an example user interface showing a metadata settings tab of a platform administration form.

FIG. 9B depicts an example user interface showing a fees and payments tab of a platform administration form.

FIG. 9C depicts an example user interface showing a curator tab of a platform administration form.

FIG. 9D depicts an example user interface showing force update project script tab of a platform administration form.

FIG. 9E depicts an example user interface showing a team members tab of a platform administration form.

FIG. 9F depicts an example user interface showing an authorized artists tab of a platform administration form.

FIG. 9G depicts an example user interface showing a featured project tab of a platform administration form.

FIG. 9H depicts an example user interface showing a beneficiary tab of a platform administration form.

FIG. 9I depicts an example user interface showing a withdraw tab of a platform administration form.

FIG. 10A depicts an example user interface showing a detail view of an edition of a generative art project.

FIG. 10B depicts an example user interface showing a metadata information readout tab of a project edition details form.

FIG. 10C depicts an example user interface showing an edition messages tab of a project edition details form.

FIG. 10D depicts an example user interface showing an edition messages tab of a project edition details form that includes a message associated with the token.

FIG. 10E depicts an example user interface showing an edition event history tab of a project edition details form.

FIG. 10F depicts an example user interface showing a transfer edition tab of a project edition details form.

FIG. 10G depicts an example user interface showing a project information tab of a project edition details form.

FIG. 11A depicts an example user interface showing an asks tab of a marketplace overview.

FIG. 11B depicts an example user interface showing an offers tab of a marketplace overview.

FIG. 11C depicts an example user interface showing an auctions tab of a marketplace overview.

FIG. 11D depicts an example user interface showing a list for a specified price tab for a marketplace form associated with a project and edition shown to the owner.

FIG. 11E depicts an example user interface showing a make offer tab a for a marketplace form associated with a project and edition shown to a third-party.

FIG. 11F depicts an example user interface showing a create auction tab for a marketplace form associated with a project and edition shown to the owner.

FIG. 11G depicts an example user interface showing auction tab for a marketplace form associated with a project and edition shown to the owner after creating an auction depicts but before the first bid.

FIG. 11H depicts an example user interface showing an auction tab a for a marketplace form associated with a project and edition shown to a third-party that is not the high bid.

FIG. 11I depicts an example user interface showing an auction tab for a marketplace form associated with a project and edition shown to the current high bidder.

### DETAILED DESCRIPTION

In the following description, and for the purposes of explanation, numerous specific details are set forth in order to provide a thorough understanding of the various aspects of the claimed invention. The disclosure is of course, broader than the claimed invention and is believed to contain numerous different inventions in various forms. The present disclosure describes matter, which may (in this application or a continuing application) be claimed as an invention. It will be understood, however, by those skilled in the relevant arts, that the claimed invention may be practiced without these specific details. In other instances, known structures and devices are shown or discussed more generally in order to avoid obscuring the claimed invention. In many cases, a description of the operation is sufficient to enable one to implement the various forms of the claimed invention, particularly when the operation is to be implemented in software. It should be noted that there are many different and alternative configurations, devices and technologies to which the disclosure may be applied, and which may (in this application or a continuing application) be claimed as an invention. The full scope of the disclosure which may (in this application or a continuing application) be claimed as an invention, is not limited to the examples that are described below.

Among those benefits and improvements that have been disclosed, other objects and advantages of the disclosure will become apparent from the following description taken in conjunction with the accompanying figures. Detailed forms of devices, systems and methods are disclosed herein; however, it is to be understood that the disclosed forms are merely illustrative of the numerous inventions contained in the disclosure, which may (in this application or a continuing application) be claimed as an invention, which may be embodied in various forms. In addition, each of the examples given in connection with the various forms of the devices, systems and methods disclosed which are intended to be illustrative, and not restrictive.

The subject matter regarded as the invention in the present application is particularly pointed out and distinctly claimed in the CLAIMS. The invention, however, both as to organization and method of operation, together with any provided objects, features, and advantages thereof, may best be understood by reference to the following detailed description when read with the accompanying drawings.

The figures constitute a part of this specification and include illustrative forms of the disclosed devices, systems and methods, which may (in this application or a continuing application) be claimed as an invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the disclosed devices, systems and methods. Further, where considered appropriate, reference numerals may be repeated among the figures to indicate corresponding or analogous elements.

Because the illustrated forms of the disclosed devices, systems and methods may for the most part, be implemented using electronic components and circuits known to those skilled in the art, details will not be explained in any greater extent than that considered necessary, for the understanding and appreciation of the underlying concepts of the present disclosure and in order not to obfuscate or distract from the teachings of the present disclosure. However, various example implementations may be provided to illustrate some of the many forms in which devices, systems and methods implementing the disclosure may take.

Any reference in the specification to a method should be applied mutatis mutandis (with any necessary changes) to a system capable of executing the method. Any reference in the specification to a system should be applied mutatis mutandis to a method that may be executed by the system.

Throughout the specification and claims, the following terms take the meanings explicitly associated herein, unless the context clearly dictates otherwise. The phrases “in one embodiment,” “in one form,” “in an example embodiment,” “in an example form,” “in some embodiments,” “in some forms,” and other similar phrases as used herein do not necessarily refer to the same embodiment(s) or form(s), though it may. Furthermore, the phrases “in another embodiment,” “in another form,” “in an alternative embodiment,” “in an alternative form,” “in some other embodiments,” and “in some other forms” or similar phrases as used herein do not necessarily refer to a different embodiment or form, although it may. Thus, as described below, various forms of the devices, systems and methods disclosed herein may be readily combined, without departing from the scope or spirit of the disclosure which may (in this application or a continuing application) be claimed as an invention.

The use of the word “coupled” or “connected” implies that the elements may be directly connected or may be indirectly connected or coupled through one or more intervening elements unless it is specifically noted that there must be a direct connection.

In addition, as used herein, the term “or” is an inclusive “or” operator and is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

As will be appreciated by one skilled in the art, the present disclosure describes matter, which may (in this application or a continuing application) be claimed as an invention, may be embodied as a system, method, computer program product or any combination thereof. Accordingly, this matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this matter takes the form of a computer program product embodied in any tangible medium of expression having computer usable program code embodied in the medium.

The present disclosure describes matter, which may (in this application or a continuing application) be claimed as an invention, may be described in the general context of computer-executable instructions, such as program modules, being executed by a computer. Generally, program modules include routines, programs, objects, components, data structures, etc. that perform particular tasks or implement particular abstract data types. The matter may also be practiced in distributed computing environments where tasks are performed by remote processing devices that are linked through a communications network. In a distributed computing environment, program modules may be located in both local and remote computer storage media including memory storage devices.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

Computer program code for carrying out operations of the present disclosure may be written in any combination of one or more programming languages, including any language suitable for programming smart contracts on any crypto blockchain such as Solidity, an object-oriented programming language such as Java, Smalltalk, C++, C# or the like, conventional procedural programming languages, such as the “C” programming language, and functional programming languages such as Prolog and Lisp, machine code, assembler or any other suitable programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network using any type of network protocol, including for example a local area network (LAN) or a wide area network (WAN), or the connection may be made to an external computer (for example, through the Internet using an Internet Service Provider).

The present disclosure describes matter, which may (in this application or a continuing application) be claimed as an invention, is described below with reference to flowchart illustrations and/or block diagrams of methods, apparatus (systems) and computer program products according to various forms of the disclosed devices, systems and methods. It will be understood that each block of the flowchart illustrations and/or block diagrams, and combinations of blocks in the flowchart illustrations and/or block diagrams, can be implemented or supported by computer program instructions. These computer program instructions may be provided to a processor of a general-purpose computer, special purpose computer, microcontroller, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block being or blocks.

The blockchain used by any form of the present disclosure may be Ethereum, an Ethereum Virtual Machine compatible blockchain, Tezos, Bitcoin, or any other cryptographic blockchain system including Layer 2, etc. systems that interact with Layer 1 blockchains.

The present disclosure describes matter, which may (in this application or a continuing application) be claimed as an invention, which is operational with numerous general purpose or special purpose computing system environments or configurations. Examples of well-known computing systems, environments, and/or configurations that may be suitable for use with the disclosed devices, systems and methods include, but are not limited to, personal computers, server computers, cloud computing, hand-held or laptop devices, multiprocessor systems, microprocessor, microcontroller or microcomputer based systems, set top boxes, programmable consumer electronics, ASIC or FPGA core, DSP core, network PCs, minicomputers, mainframe computers, distributed computing environments that include any of the above systems or devices, and the like.

The headings provided in the disclosure below are provided merely for convenience to the reader and should not be used to in any way to limit any claimed invention.

I. Non-Fungible Tokens Generally.

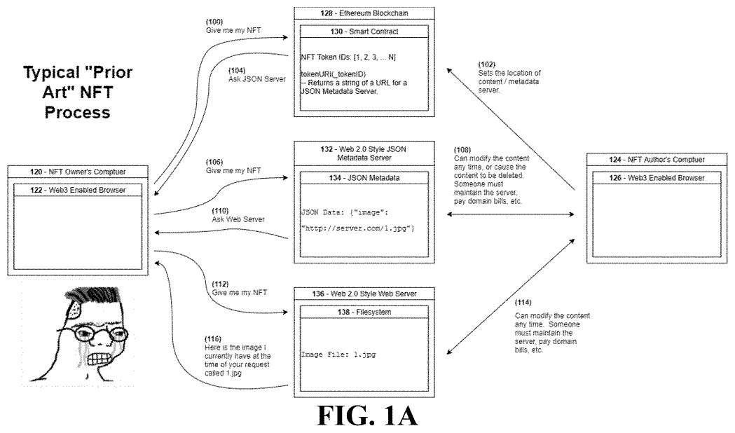

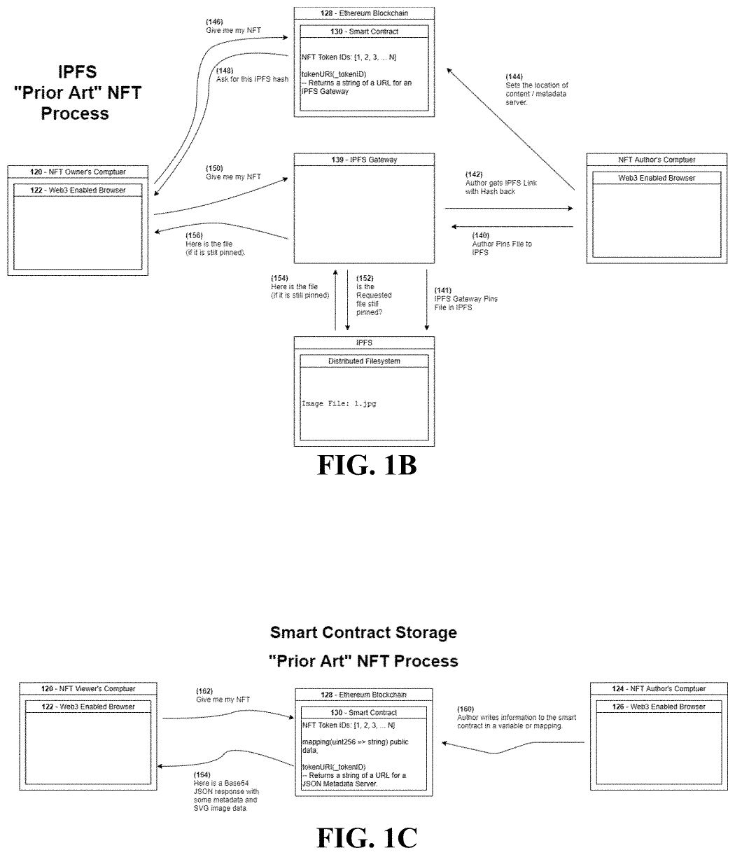

With reference to FIG. 1A, a typical “prior art” NFT system is shown. At act 102, an NFT author uses computer 124 and Web3 enabled browser 126 to instruct a smart contract 130 on the Ethereum blockchain 128 to set the location of content/metadata 134 on metadata server 132 associated with one or many NFTs. At act 108, The NFT author (or potentially anyone else at any later time) then configures or modifies a metadata server 132 with JSON formatted metadata 134 that references a file on the filesystem 138 of a web server 136. At act 114, the NFT author (or potentially anyone else at any later time) sets or modifies the content referenced by the JSON metadata on the filesystem 138 of a web server 136. Importantly, there is no guarantee that the JSON Metadata 134 of the JSON server 132 or the Filesystem 138 of webserver 136 will remain available or will only be modified by the NFT author.

At act 100, an NFT Owner (or Viewer) using computer 120 and web3 enabled browser 122 can request a particular NFT associated with a tokenId from the smart contract 130 on the Ethereum blockchain 128. At act 104, a response is received that instructs the web3 enabled browser 122 to ask an off-chain JSON server. At act 106, the web3 enabled browser 122 asks the JSON Metadata Server 132 for the information. At act 110, the JSON Metadata server 132 may respond (if it is still operating at the time of the request) with JSON Metadata 134, instructing the web3 enabled browser to contact yet-another system. At act 112, the web3 enabled browser 122 asks web server 112 for the information. At act 116, the webserver 136 may respond (if it is still operating and has the requested information at the time of the request) with the requested file from filesystem 138.

The metadata server 132 and associated metadata 134, as well as the web server 136 and contents of file system 138 may be modified at any time by anyone with permissions on those systems irrespective of their relationship to the NFT author 124. Therefore, there are a number of ways that the NFT owner or viewer may be provided with inauthentic information associated with the NFT or that may render the NFT inoperative.

With reference to FIG. 1B, another “prior art” NFT system is shown that utilizes the interplanetary filesystem (IPFS) distributed filesystem to store metadata and other content. At act 140, an NFT author uses computer 124 and Web3 enabled browser 126 to upload and pin a file into the IPFS system using an IPFS gateway 139 or similar system. At act 141, the IPFS gateway 139 pins the file in IPFS and receives a content ID hash. At act 142, an IPFS hash is returned that provides the location of the content based on the hash of the content. At act 144, the NFT author instruct a smart contract 130 on the Ethereum blockchain 128 to set the location of content/metadata based on the IPFS hash.

At act 146, an NFT Owner (or Viewer) using computer 120 and web3 enabled browser 122 can request a particular NFT associated with a tokenId from the smart contract 130 on the Ethereum blockchain 128. At act 148, a response is received that instructs the web3 enabled browser 122 to ask an IPFS gateway 139 for a particular IPFS hash. At act 150, the web3 enabled browser 122 asks the IPFS gateway 139 for the content associated with the hash. At acts 152 and 152, the IPFS gateway requests and retrieves the content from IPFS (if it is still pinned at the time of the request). At act 156, the IPFS gateway 139 responds to the web3 enabled browser with the content associated with the hash (if it was still pinned).

To the extent that the content referred to by the content hash has become unpinned from the IPFS system, it will no longer be available when requested by the NFT owner or subsequent viewers. Furthermore, to the extent the author desires to extend or supplement the information, it is not possible without causing the IPFS hash to change.

With reference to FIG. 1C, a “fully on-chain” “prior art” NFT system is shown that utilizes a smart contract to define the NFT. At act 160, an NFT author uses computer 124 and web3 enabled browser 126 to deploy a smart contract 130 to the Ethereum blockchain 128 along with variables or mappings including additional data. The smart contract fully defines the NFT including metadata and any code to generate scalable vector graphics (SVG) images.

At act 162, an NFT Owner (or Viewer) using computer 120 and web3 enabled browser 122 can request a particular NFT associated with a tokenId from the smart contract 130 on the Ethereum blockchain 128. At act 164, a response is received that provides base64 encoded JSON response with JSON Metadata and an inline SVG image directly from the Ethereum EVM.

In this instance, the author of the NFT had to write information to expensive contract storage. According to the Ethereum Yellow Paper, writing information to the smart contract storage costs 625 gas/byte.

Furthermore, this method is limited to writing code that can be interpreted and executed by the EVM to produce an SVG image. Using this method, the NFT author in this instance is (a) unable to use a more capable or processor intensive programming technique to define the NFT and/or (b) use more affordable log storage that only costs 8 gas per byte (72× less).

II. Immutable and Expandable NFTs Stored Completely on a Blockchain.

Decentralized applications provided censorship resistance, security, and the ability to create digital assets with real value. Blockspace, however, can be expensive. Contract storage costs 625 gas per byte, whereas log storage costs 8 gas per byte; this is 78 times less expensive.

With systems and methods described herein, the backend business logic of distributed application (Dapp) may be stored on a decentralized blockchain in a smart contract, and the front-end may be distributed as a React HTML application via IPFS and can be run on the end user's computer.

The valuable assets that do not need to be run on the Ethereum Virtual Machine but that are used or created by the decentralized application may be defined in code blocks that are optionally stored in blockchain log storage using what are referred to as Posts in this disclosure and held by the authors in individual NFTs referred to in this disclosure as Pages or Namespaces.

The result of this pattern is a distributed unstoppable application that is gas efficient, secure, censorship-resistant, and has building blocks with IP rights that can be protected and licensed individually and can be traded without impacting the functionality of the Dapp.

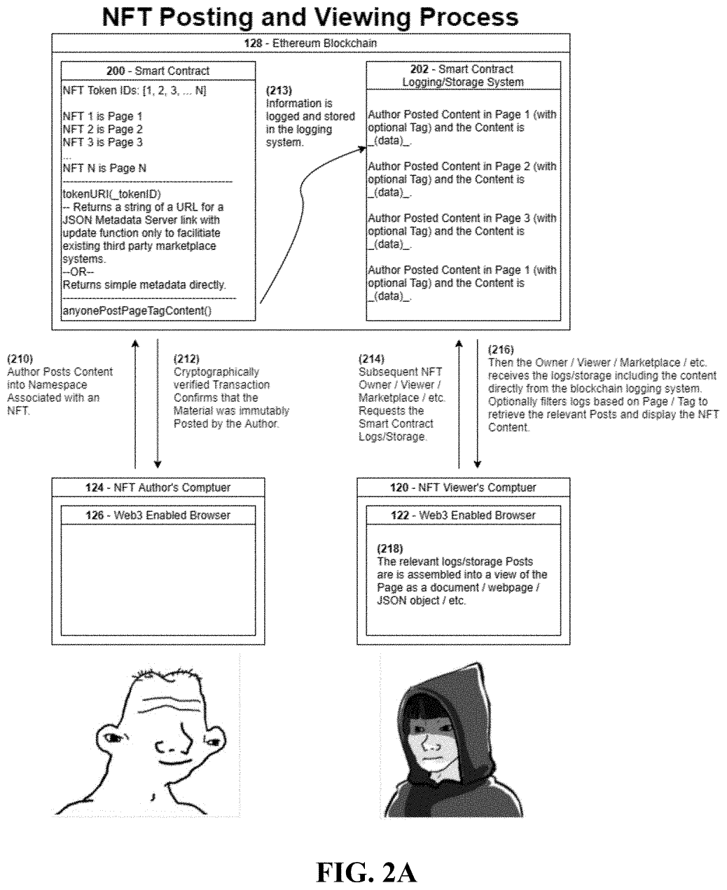

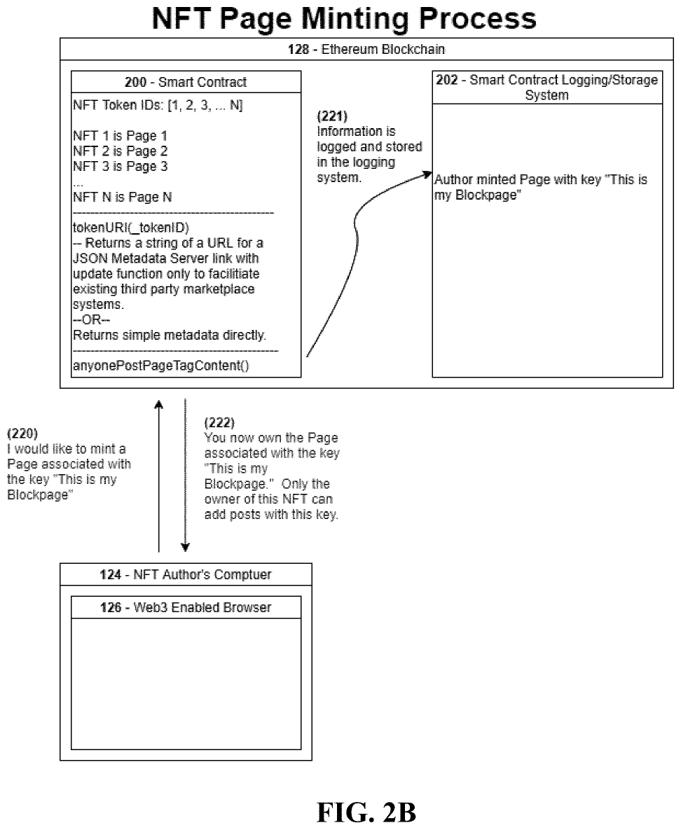

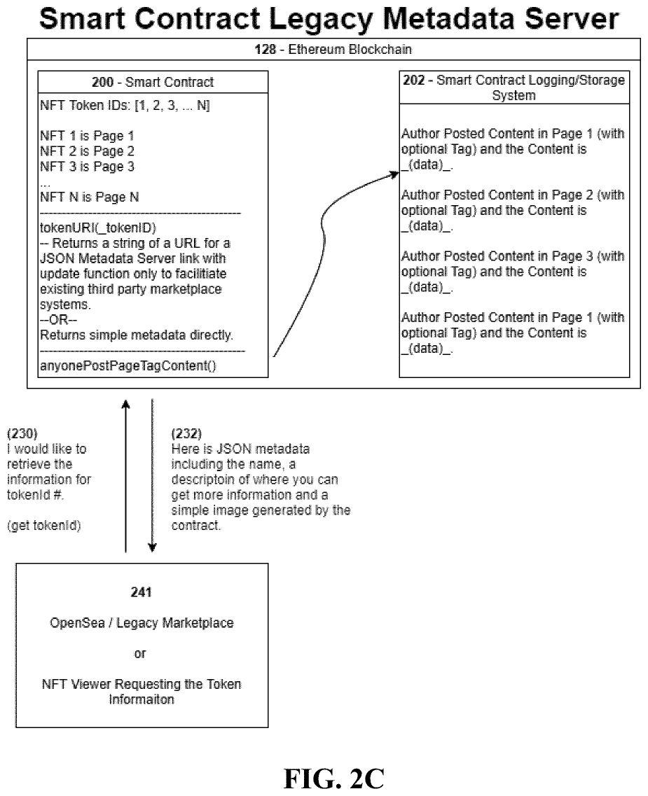

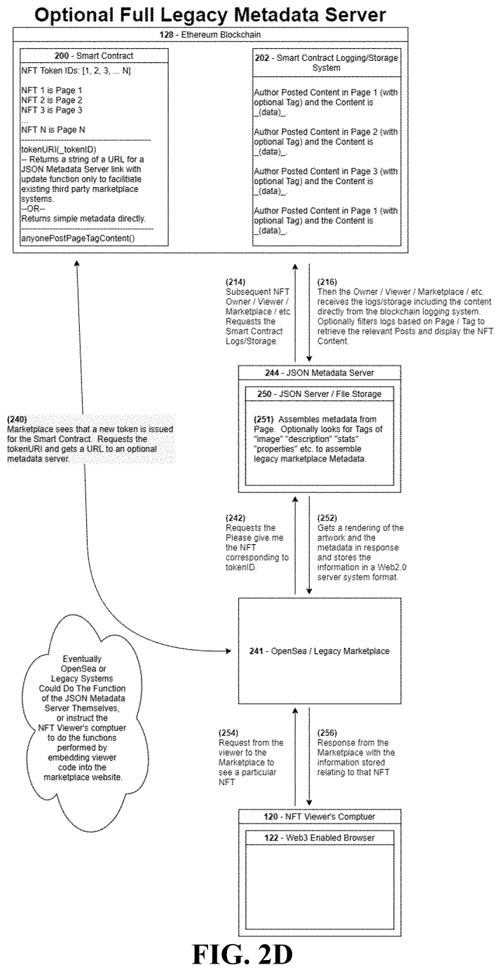

With reference to FIG. 2B, an example system and method of minting a Page NFT is illustrated. A smart contract 200 is deployed on the Ethereum blockchain 128 (see for purposes of illustration the smart contract deployed on Mainnet Ethereum at 0x499f4943fB86717adcE584927E6AB5a172f03001).

At act 220, an NFT author using computer 124 and web3 enabled browser 126 submits a mint transaction to the smart contract 200 including a Page identifier. As part of the minting transaction, at act 221 the smart contract 200 emits an event that is logged into (or that is written into a variable in) the smart contract logging (or storage) system 202. The event can be used later if desired. In addition, a tokenId is associated with the Page name and an address of the owner. Optionally, a royalty manger contract (see for purposes of illustration the smart contract deployed on Mainnet Ethereum at 0x4a982a67312a34ef2a0047e730b58f1de05e92b1) may be created and associated with the Page or the original Page author. At act 222, a transaction confirmation is provided to the NFT author's web3 enabled browser 126 confirming that the page was minted.

With reference to FIG. 2A, an example system and method of posting to and viewing from a tamper proof, immutable, and expandable on-chain NFT storage system is illustrated. A smart contract 200 is deployed on the Ethereum blockchain 128 (see for purposes of illustration the smart contract deployed on Mainnet Ethereum at 0x499f4943fB86717adcE584927E6AB5a172f03001).

At act 210, an NFT author using computer 124 and web3 enabled browser 126 submits a Post transaction to the smart contract 200 including Content. The Post transaction may optionally define a Page and Tag to be associated with Content. As part of the Post transaction, at act 213 the smart contract 200 emits an event that is logged into (or that is written into a variable in) the smart contract logging (or storage) system 202. At act 212, a transaction confirmation is provided to the NFT author's web3 enabled browser 126.

At act 214, an NFT owner/viewer/marketplace/etc. using a computer 120 and web3 enabled browser 122 requests the NFT from the Ethereum blockchain via smart contract 200 and the smart contract logging system 202. At act 216, the logs are provided to the recipient's web3 enabled browser 122. The logs may optionally be filtered based on any specified Page and Tag information to retrieve only relevant Posts for the desired NFT content. At act 218, the web3 browser assembles the relevant Posts into a view of the Page as a document.

Both the NFT Author and the NFT viewer can be confident that the information has not been tampered with, because it is defined completely by information that is cryptographically verified to be authentic by the Ethereum blockchain. The NFT Author or Page Owner can supplement the Page with additional Posts but cannot modify or delete Posts that have already been made.

Furthermore, if the smart contract is using log storage (as opposed to contract storage) for the Post information, the cost to write information can be reduced by a factor of 72× because it is only 8 gas per byte to write to log storage as opposed to 625 gas/byte for contract storage.

II.A. Post Features. Each Post is associated with its Author, a Page (sometimes referred to as a Namespace), a Tag (sometimes referred to as a Cite), and Content (sometimes referred to as Text). The Tag and/or Content may also include Commands or other modifiers.

Example Tag/Content Commands. In forms of the disclosure, Tags can be used to configure the display of the Post information in a metadata server or client application.

Reply. Tag a post with R[Tx] (where [Tx] is the transaction hash) to signify that it is a reply to another Post transaction. “>R[Tx]” in the body of the post can be replaced with a link to the parent post.

Quote. Tag a post with Q[Tx] to signify that it is a quote with comment of another post. “>Q[Tx]” in the body of the post can be replaced with a link to the parent post or can instruct the client software to insert a rendering of the parent post as a quoted block or similar.

Link. Include “L[Tx]” or “][([Page Name])” in the body of an immutable to link to another Post transaction [Tx] or Page [Page Name]. The client software can look for and replace those codes with links to the immutable formatted as a HTTP URL.

IPFS://. Type an IPFS:// URL in the body of an immutable to link to an IPFS resource. The client software can look for and replace those with IPFS links routed through a gateway. This way, if gateways change over time, the IPFS links can still be rendered in a working manner.

Hide Post. Create a Post with the Tag “H[Tx]” where [Tx] is the transaction hash of another immutable in the Page. The client software can look for Posts with the cite H[Tx] and if there is a post in the page with the transaction hash [Tx], the client software can hide the Post with the transaction hash [Tx]. The Post still exists on the blockchain, and can be referenced by others, but for the display of the Page in the client application, the Post will be hidden. Thus, while Posts cannot be deleted, a Page owner may choose to hide Posts on the Page.

Default Filter Start/End. Create a Post with the tag start_filter or end_filter. In the body of the post, only place the block number for the start or end filter. The client software can look for these Posts and configure the start and end block filters accordingly. Thus, while Posts cannot be deleted, a Page owner can update start and end filters to update their Page over time while hiding outdated information by default.

Only Owner/Account(s) Code. Create a Post with the Tag “owner” or an account allow list or similar. The client software can look for this when rendering the Page, the client software can hide that Post from anyone except for the owner of the NFT.

Only Member Code. Create a Post with the tag “member” or similar. The client software can look for this when rendering the page, the client software can hide that post from anyone except for a member of the Page. A member of the page would have another NFT (Immutables Club/Membership) referencing the Page and that is currently valid (e.g., within a period covered by a subscription payment).

Style/Foreground/Background Color. Create a post with the Tag style, fgcolor, bgcolor, etc. In the body of the post, place cascading style sheet (CSS) styles or color codes. The client software can look for these posts, and configure the style and/or color scheme as appropriate

Example Metadata Tags. Tags may also be used to signify posts containing metadata or metadata features.

Collection Tag. For example, a Tag specifying the collection to which an NFT should belong could be provided by creating a Post with Tag “collection” and a Content containing the name of the collection.

Alternatively, the collection Tag on a Post that informs observers that a NFT Page defines a collection of Pages. The Content of the Post can reference the tokenId of the Pages, the Page names, or transaction hashes of the token minting events. Clients, Metadata servers or marketplaces can then analyze scarcity of the items within the collection. Alternatively, or additionally, the items in the collection may Tag to the main collection. The metadata server, marketplace, or clients can then find all the items referencing the main collection.

Content Tag. A video or content tag can be used to include a reference to viewer software that informs a marketplace/viewer or metadata server what the associated content is and how to render it.

Individual Metadata Key Tags. Any of the traditional key and values used in current NFT metadata standards can be used as a Tag and the corresponding values be used as the Content of a post.

General Metadata Tag. Or a general “metadata” Tag could be used with the body of the Post including a JSON object of the current metadata.

To the extent the metadata needs to be updated, more recent Posts including a particular Tag may be used as the current information relating to that Tag.

Content Formatting. Information included in the Content portion of a Post may be formatted using any markup or markdown language, or other scheme.

Cross-Contract Post References. Given a standard format, different smart contracts can implement this Post standard format (e.g., Page, Tag, Content) to be able to cross-link to each other in their respective front-end clients and metadata servers.

II.B. Example Metadata Server Types

With reference to FIG. 2C, an example system and method for a smart-contract based metadata server to provide support for legacy marketplaces is illustrated. A smart contract 200 is deployed on the Ethereum blockchain 128 (see for purposes of illustration the smart contract deployed on Mainnet Ethereum at 0x499f4943fB386717adcE584927E6AB5a172f03001).

At act 230, an NFT owner/viewer/marketplace/etc. 241 requests the NFT from the Ethereum blockchain via smart contract 200. At act 232, a response is received from the Ethereum blockchain that includes a base64 encoding of metadata and an SVG image. The metadata may in include parameters such as the Page name, and a URL or ENS link to view the Page directly in a client webpage or application that assembles the Posts for the Page into an easily viewed document.

With reference to FIG. 2D, an example system and method for a metadata server to provide support for legacy marketplaces is illustrated. A smart contract 200 is deployed on the Ethereum blockchain 128 (see for purposes of illustration the smart contract deployed on Mainnet Ethereum at 0x499f4943fB86717adcE584927E6AB5a172f03001). A metadata server 244 with JSON server and file storage 250 is made available.

At act 240, an NFT owner/viewer/marketplace/etc. 241 that is monitoring the blockchain for new NFTs detects that a new token was issued for smart contract 200. Entity 241 requests the token URI to get a URL to the optional metadata server 244 for the requested tokenId. At act 242, the entity 241 requests the NFT corresponding to the tokenId from the metadata server 244. At act 214, software 250 running on server 244 requests the NFT from the Ethereum blockchain via smart contract 200 and the smart contract logging system 202. At act 216, the logs are provided to the metadata server 244 and software 250. The logs may optionally be filtered based on any specified Page and Tag information to retrieve only relevant Posts for the desired NFT content. The software 250 prepares a response including metadata and image data formatted as expected by 241 (for example as JSON Object including metadata and image data or references). At act 252, entity 241 receives the formatted data from the server 244 and software 250. Entity 241 may store the data contained in response 252 in their system to facilitate queries from third parties.

At act 254, an NFT consumer using a computer 120 and web3 enabled browser 122 requests the NFT from the entity 241. At act 256, entity 241 responds with a webpage containing information previously retrieved and stored regarding the particular NFT.

II.C. Example Use Cases. There are many example use cases that can be imagined, including the following:

II.C.1. Art/Photo Collection. One use case for NFTs using this system may be an art or photo NFT series or collection. A main index Page can be minted for the collection. Then, a Page may be minted for each work in the series. Posts can be inserted into each of the Pages in the Collection. The index Page may be configured to list the Pages corresponding to the editions or individual works in the series. Metadata can define the scope of the series is limited to those works. The author of the works may hold or sell the Index and each of the Editions in the Collection separately as NFTs.

II.C.2. Blogs/Verified Press Releases. Corporations or other people may use the system to create a webpage, blog, or issue press releases that are verified by Ethereum encryption. Because each Post must be signed by the author and can only be inserted into Pages owned by the Author, this can function as a verified publishing system where each Page is essentially equivalent to a verified social media profile or webpage. Only a holder of the private Ethereum key of the owner of the page may post into it, and each Post is clearly associated with the author.

For example, on Sep. 13, 2021, a hoax press release purporting to be from Walmart stating that they were doing a partnership with Litecoin moved the price of Litecoin before it could be discredited. Using a cryptographically verified publication system, the Walmart press release could not have been forged, and the price of Litecoin may not have been manipulated with a false press release.

Text content can be added and formatted using markdown. Image content can be added by reference to an IPFS content hash, or directly using base64 encoding. Source code can be added as formatted text. The page itself can be styled using CSS so that this data can be styled for presentation by the author. Each post is immutable and signed by the poster. This verifies the author of the content and prohibits the author or subsequent owners from changing the content of that particular Post later.

II.C.3. IP Licensing and Royalties. The content is stored all on-chain in log storage (or optionally contract storage). The Page is an NFT owned by the author. The page also has an associated royalty manager contract that is controlled by the original NFT author, and transfers separately from the page NFT. This enables the author to receive royalties from the trading of the asset so long as they maintain control of the royalty manager contract.

This format also lends itself to transparent licensing and payments. License terms can be placed on the Page in a separate Post, and payments can be associated with the Post transaction to show assent and adoption of the author provided terms.

An NFT Page can be made for a piece of IP, and that Page can be owned and sold like any other ERC-721 compliant NFT. It can also be licensed. For example, a Post can be inserted into the page with licensing terms. This Post may be a traditional contract that third parties can read and assent to. Third parties wishing to assent to the licensing terms can reply with acceptances of the offer and include a transaction hash to a payment for the licensing fee according to the terms of the post. The payment may be made as part of the acceptance transaction or separately. There may also be a payment feature built into the smart contract and front-end application. Therefore, instead of clicking a “reply” button there may be a “pay” or “tip” button. The payment may go to the author, the owner, or split between author, owner and the platform. Payments can be spit in any way imaginable. For example, payments may be split three ways (1) the platform contract/owner (10%) (2) the current NFT owner (80%) and (3) the original NFT author (10%). There may be bounties offered for third-parties to report unlicensed use. To automate obtaining a protectable legal right, the platform may provide a link to have a professional assist the author with registering a copyright of the content on the Page.

III.C.4. Data Shortener Use Case. A Post can be created to use the smart contract as a “data shortener” and permanent storage system—like a web2.0 style link shortener but instead of redirecting users to another location, it merely provides content that will not become unavailable because the content is stored on-chain.

A user could log data into the smart contract with a Post. This verifies the user's identity and associates the user as the poster or author of the content using the Ethereum system. The data is written to a Post and optionally associated to a Page with optional citation to another Ethereum transaction or other data via the Tag or Cite. This can facilitate lookup or relating the information to another item of content. The data is stored in the Ethereum event logging system (or optionally contract storage). A transaction hash for that data is returned to the poster. A third party may use the transaction hash to look up and retrieve the data from the Ethereum logging system, while assuring that the item is authentic.

III.C.4.i Data Shortener Use Case: Game or Dapp Assets. Applications can also use the transaction hash to pull the item from the Post to use it for further processing. For example, a verified computer program or portion thereof can be placed in a Post and then referenced by an external application.

The external application can obtain the code and execute it (because it is verified and cannot be changed there is little risk of malicious interference). Then the result can be presented by the client computer system.

For example, each character, level, or asset in an online game can be defined by separate Page NFTs. The main Dapp for the game can then reference the code transaction hashes to pull in the code that defines the level, character, or other asset. This information can then be cached on the client system by the main Dapp client software for speed and updated as needed if new post transactions are added to the associated NFT Pages. Third-party developers and fans of the game may create additional assets in a similar manner that the main game Dapp could import and use. Each of these game asset NFTs could then be sold to collectors to fund further development of the game, and the game functionality would not be impacted because the existing code transactions can never be modified by subsequent owners because they are immutable.

II.D. Example Implementation of a Content Publishing System.

With reference to FIG. 3A, an example user interface showing a Home overview tab of a platform information modal is illustrated.

With reference to FIG. 3B, an example user interface showing a Pages explanation tab of a platform information modal is illustrated.

With reference to FIG. 3C, an example user interface showing a Posts explanation tab of a platform information modal is illustrated.

With reference to FIG. 3D, an example user interface showing a Tags explanation tab of a platform information modal is illustrated.

With reference to FIG. 3E, an example user interface showing an On Chain explanation tab of a platform information modal is illustrated.

With reference to FIG. 3F, an example user interface showing a Metadata explanation tab of a platform information modal is illustrated.

With reference to FIG. 3G, an example user interface showing a mint a Page (or namespace) modal is illustrated.

With reference to FIG. 3H, an example user interface showing an empty Page (or namespace) is illustrated.

With reference to FIG. 3I, an example user interface showing a compose a Post (or Immutable) is illustrated.

With reference to FIG. 3J, an example user interface showing an add on-chain image insertion tool tab of a compose a Post modal is illustrated.

With reference to FIG. 3K, an example user interface showing an add IPFS image insertion tool tab of a compose a Post modal is illustrated.

With reference to FIG. 3L, an example user interface showing a compose a Post modal including an on-chain image in the content of the draft post (left content pane is the code, right content pane is the preview) is illustrated.

With reference to FIG. 3M, an example user interface showing a Page including a Post is illustrated.

With reference to FIG. 3N, an example user interface showing a Page including a Post with the Post details footer expanded is illustrated.

With reference to FIG. 3O, an example Etherscan Overview user interface showing the Post depicted in FIG. 3M inserted on the blockchain is illustrated.

With reference to FIG. 3P, an example Etherscan Logs user interface showing the Post depicted in FIG. 3M inserted on the blockchain is illustrated.

With reference to FIG. 3Q, an example user interface showing a compose a Post modal configured to reply to a prior Post is illustrated.

With reference to FIG. 3R, an example user interface showing a Page and Post that includes a Reply is illustrated.

With reference to FIG. 3S, an example user interface showing a Post that is a Reply to a another Post is illustrated.

With reference to FIG. 3T, an example user interface showing a Page (or Namespace) navigation tool is illustrated.

With reference to FIG. 3U, an example user interface showing Pages associated with an account is illustrated.

With reference to FIG. 3V, an example user interface showing new Posts is illustrated.

With reference to FIG. 3W, an example user interface showing new Pages (or Namespaces) is illustrated.

With reference to FIG. 3X, an example user interface showing optional filters to apply to Posts is illustrated.

With reference to FIG. 3Y, an example user interface showing a metadata server configuration option in an administrative modal is illustrated.

With reference to FIG. 3Z, an example user interface showing a user fees configuration form in an administrative modal is illustrated.

With reference to FIG. 3AA, an example user interface showing a beneficiary form in an administrative modal is illustrated.

With reference to FIG. 3BB, an example user interface showing a withdraw tab of an administrative modal is illustrated.

With reference to FIG. 3CC, an example user interface showing Page details is illustrated.

With reference to FIG. 3DD, an example user interface showing a compose a Post (or immutable) including a Tag specifying “image” and Content including an image file is illustrated.

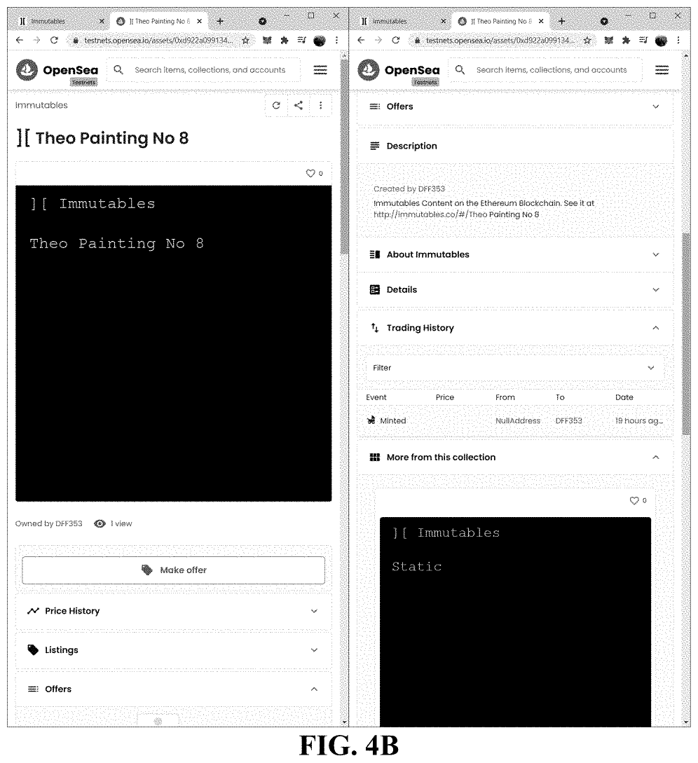

With reference to FIG. 4A, an example OpenSea marketplace user interface showing an overview of different Pages that have been minted is illustrated.

With reference to FIG. 4B, an example OpenSea marketplace user interface showing details about a particular Page NFT is illustrated.

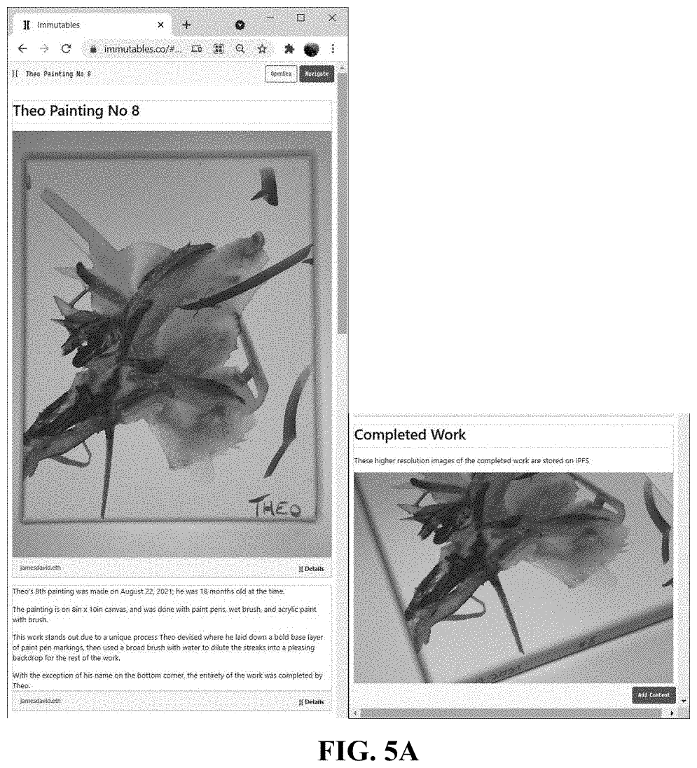

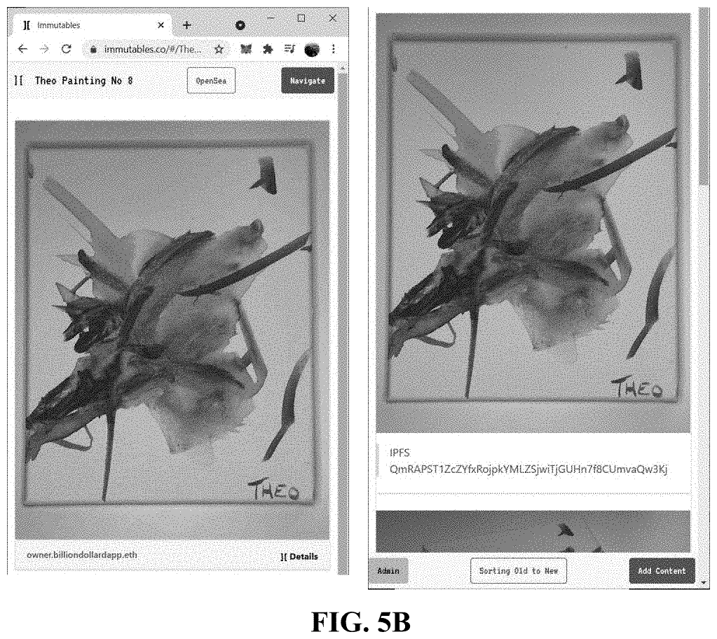

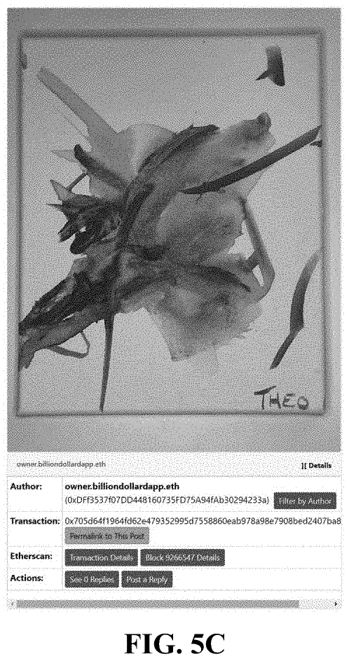

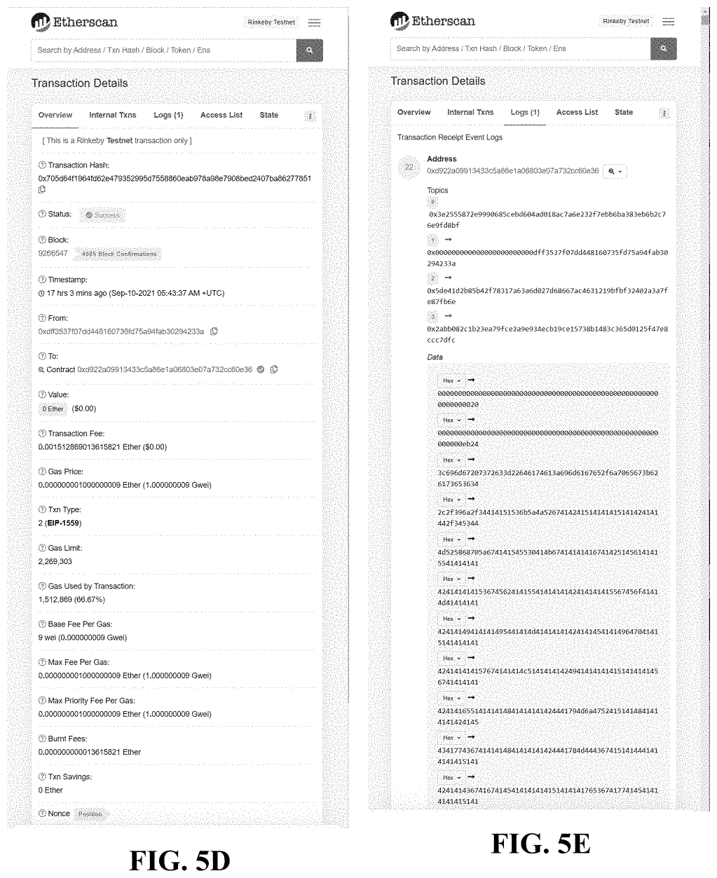

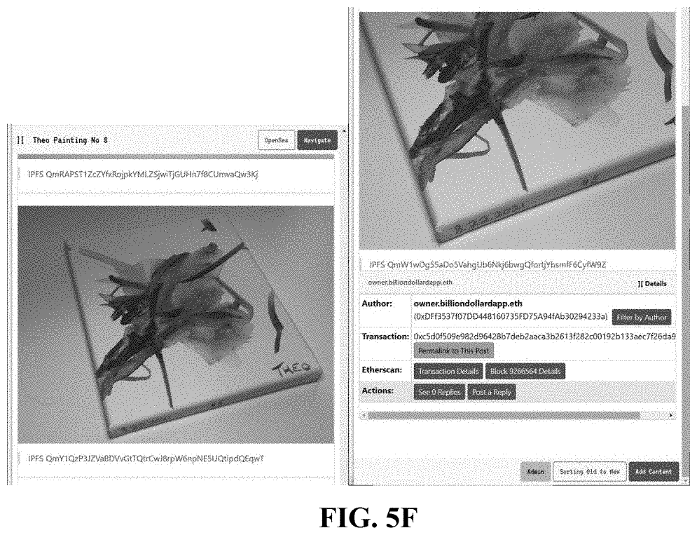

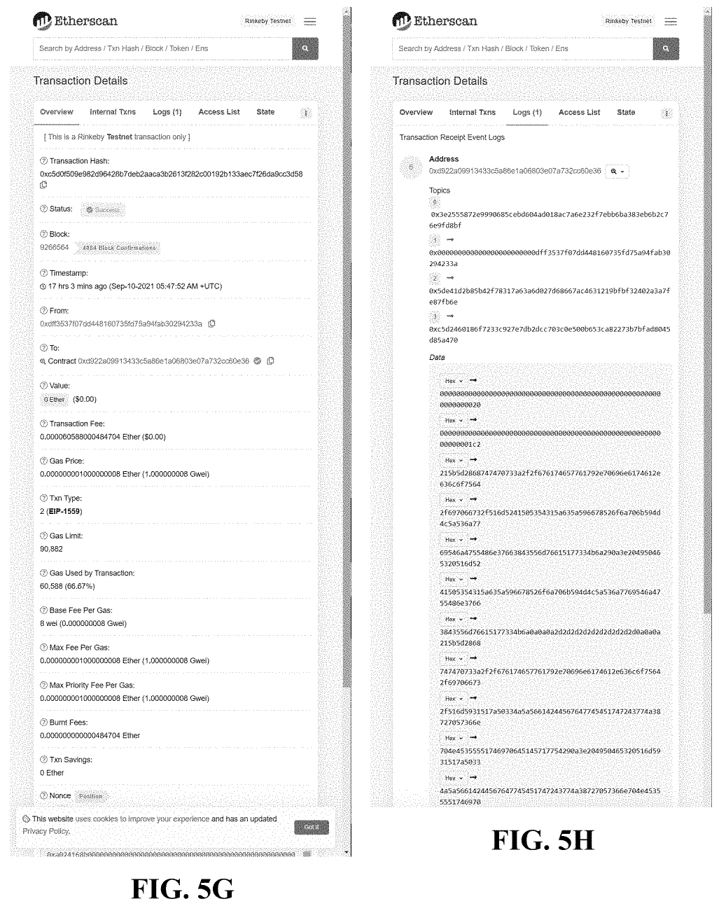

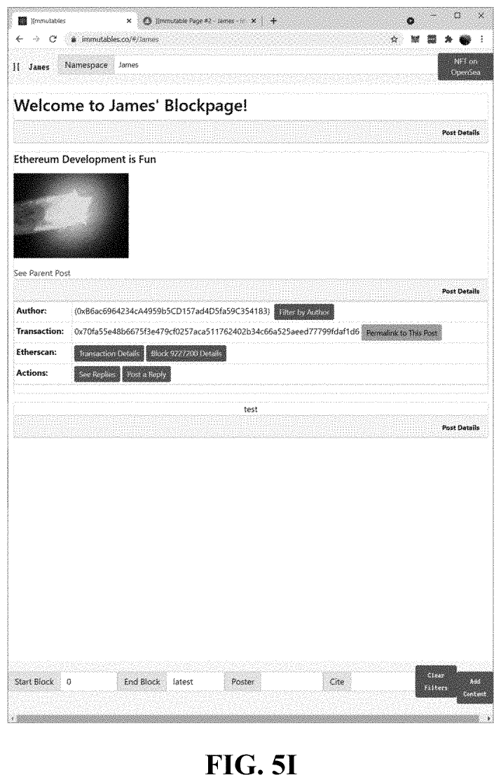

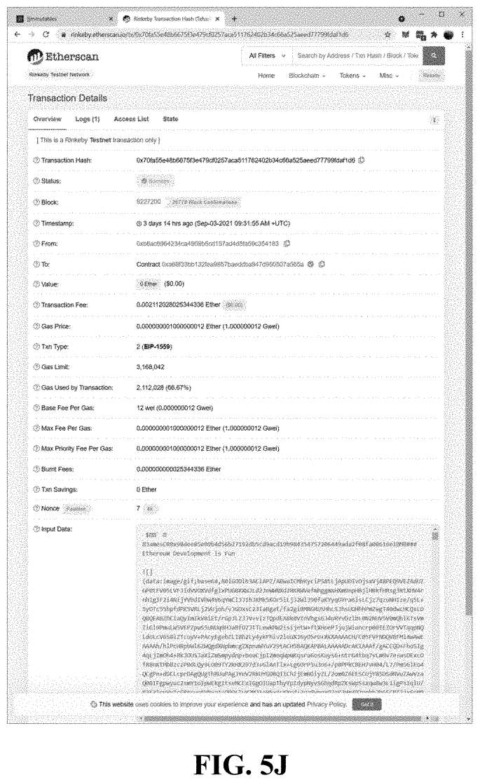

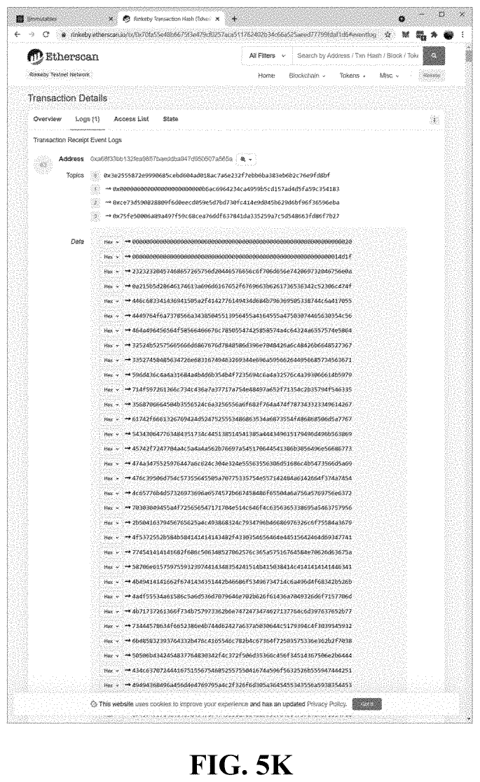

With reference to FIG. 5A, an example user interface showing a Page NFT including an on-chain image, a markdown text post, and a higher resolution IPFS image is illustrated. The first Post contains an on-chain image tagged as “image” for the metadata server. The second Post contains a description of the artwork tagged as “description” for the metadata server. Additional Posts contain links to higher resolution images hosted in the IPFS or another system.

With reference to FIG. 5B, an example user interface showing a Post including an IPFS image is illustrated.

With reference to FIG. 5C, an example user interface showing a Post including an on-chain image with the Post details table expanded is illustrated.

With reference to FIG. 5D, an example Etherscan Overview user interface showing the on-chain image inserted into the blockchain is illustrated.

With reference to FIG. 5E, an example Etherscan Logs user interface showing the on-chain image inserted into the blockchain is illustrated.

With reference to FIG. 5F, an example user interface showing a Post including an IPFS image with the Post details table expanded is illustrated.

With reference to FIG. 5G, an example Etherscan Overview user interface showing the IPFS image inserted into the blockchain is illustrated.

With reference to FIG. 5H, an example Etherscan Logs user interface showing the IPFS image inserted into the blockchain is illustrated.

With reference to FIG. 5I, an example user interface showing a Page with multiple Posts including a post with on-chain image is illustrated.

With reference to FIG. 5J, an example Etherscan Overview user interface relating to the Post illustrated in FIG. 5I was inserted into the blockchain is illustrated.

With reference to FIG. 5K, an example Etherscan Logs user interface relating to the Post illustrated in FIG. 5I was inserted into the blockchain is illustrated.

III. Applications that Store and Retrieve Code Blocks from Posts. As discussed above, Posts can define Code that is used as an asset by additional Dapps.

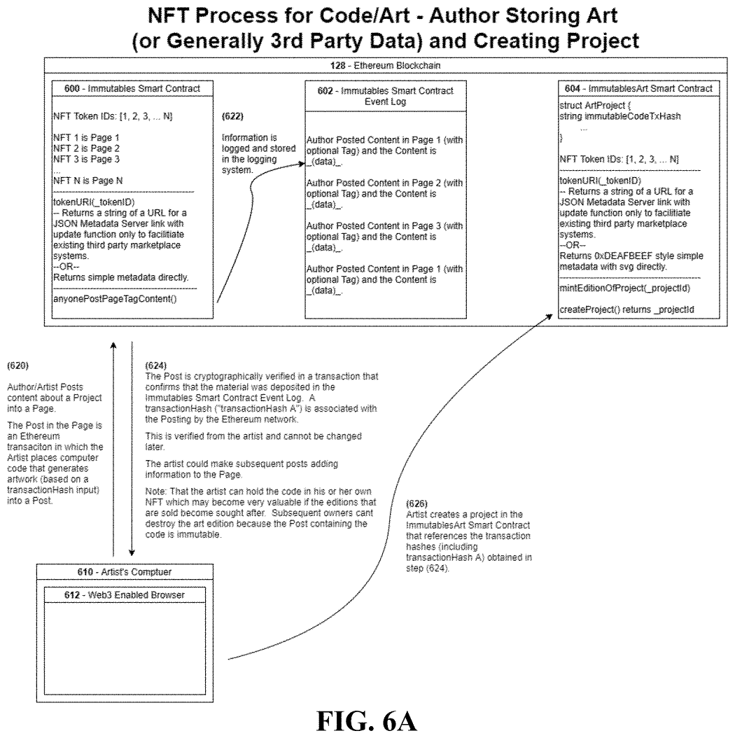

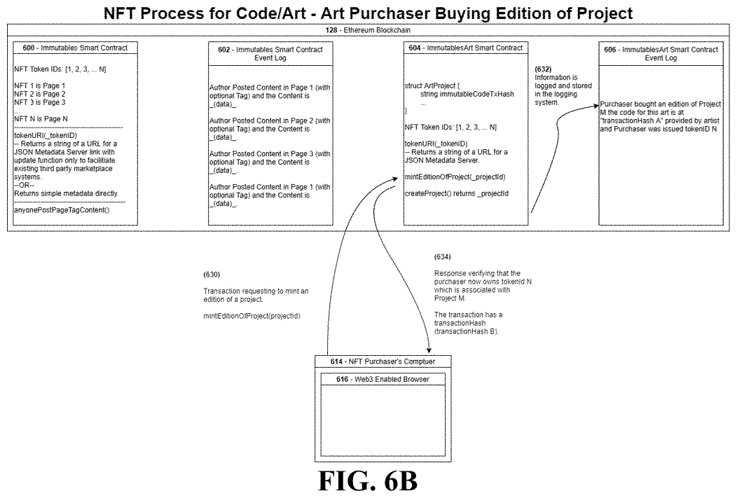

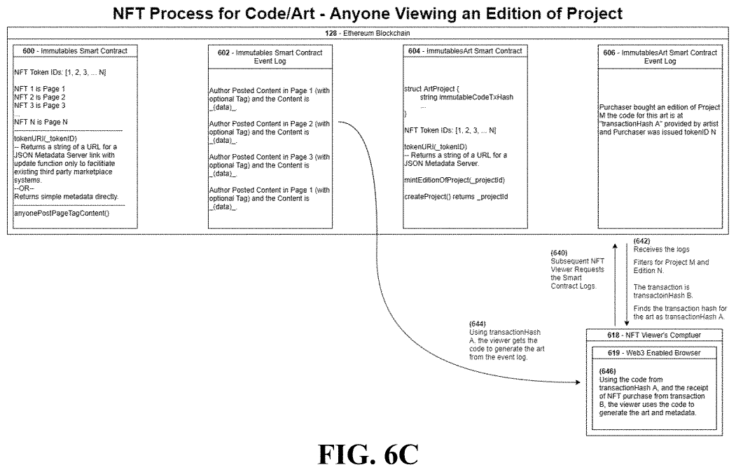

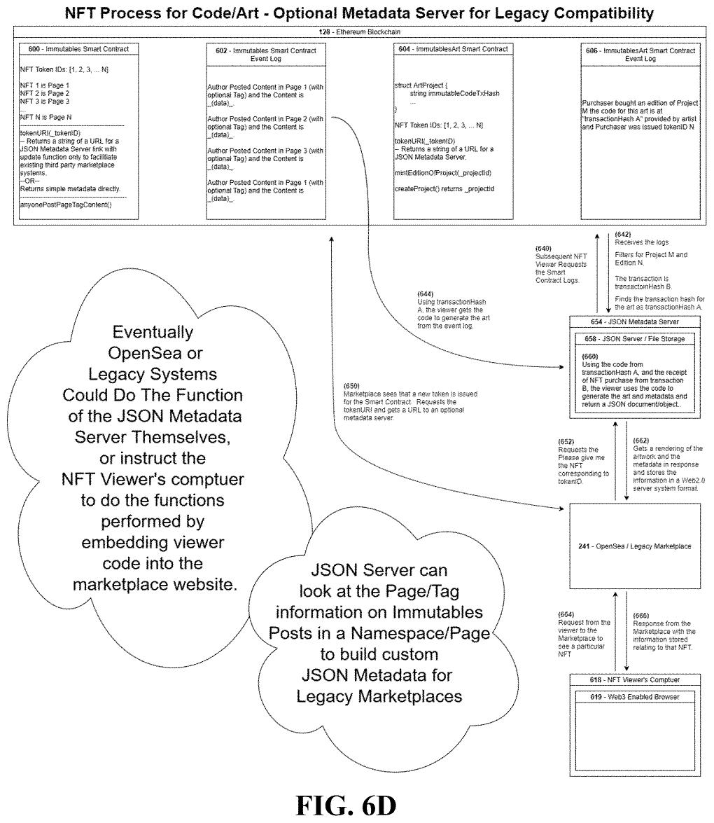

With reference to FIG. 6A, an example system and method of creating a generative art project that reference code stored in Post transaction is illustrated. A Page/Post smart contract 600 is deployed on the Ethereum blockchain 128 (see for purposes of illustration the smart contract deployed on Mainnet Ethereum at 0x499f4943fB86717adcE584927E6AB5a172f03001). An Art Project smart contract 604 is also deployed on the Ethereum blockchain 128 (see for purposes of illustration the smart contract deployed on Mainnet Ethereum at 0xA8A6CB3978e2c4EdcF5A3d0 cB3400E1E5D031479).

At act 620, an artist using computer 610 and web3 enabled browser 612 submits a Post transaction to the smart contract 600 including Content with a generative art code block. The generative art code block renders an artwork based off an input such as another hash value as the seed. The Post transaction may optionally define a Page and Tag to be associated with code Content. As part of the Post transaction, at act 622 the smart contract 600 emits an event that is logged into (or that is written into a variable in) the smart contract logging (or storage) system 602. At act 624, a transaction confirmation is provided to the NFT author's web3 enabled browser 612.

At act 626, the artist using computer 610 and web3 enabled browser 612 submits a create art project transaction to the smart contract 604. This may include a Page identifier and/or a code transaction hash defining the artwork. As part of the project creation transaction, the smart contract 604, optionally, a royalty manger contract (see for purposes of illustration the smart contract deployed on Mainnet Ethereum at 0x5e61ec18781ef933460c7ec80f36c996e023e458) may be created and associated with the art project or the artist.

With reference to FIG. 6B, an example system and method of purchasing an edition of an art project is illustrated. A Page/Post smart contract 600 is deployed on the Ethereum blockchain 128 (see for purposes of illustration the smart contract deployed on Mainnet Ethereum at 0x499f4943fB86717adcE584927E6AB5a172f03001). An Art Project smart contract 604 is also deployed on the Ethereum blockchain 128 (see for purposes of illustration the smart contract deployed on Mainnet Ethereum at 0xA8A6CB3978e2c4EdcF5A3d0cB3400E1E5D031479).

At act 630, an NFT purchaser using a computer 614 and web3 enabled browser 616 requests to mint an NFT from the Ethereum blockchain via smart contract 604 and the smart contract logging system 606. The minter may specify a project id to mint an edition of the project. At act 632, during the minting process, information is logged and stored by the smart contract 604 into the logging system 606 specifying that an edition of the specified project was minted. At act 634, a response verifying the mint transaction, and confirming the minting transaction hash, is provided to the web3 enabled browser of the purchaser 616. Optionally, during the minting process, the smart contract 604 may create a hash that defines the edition. That hash may be stored in the smart contract 604 associated with the tokenId and/or the pairing of the projectId and editionId.

With reference to FIG. 6C, an example system and method of viewing an edition of a generative art project is illustrated. A Page/Post smart contract 600 is deployed on the Ethereum blockchain 128 (see for purposes of illustration the smart contract deployed on Mainnet Ethereum at 0x499f4943fB86717adcE584927E6AB5a172f03001). An Art Project smart contract 604 is also deployed on the Ethereum blockchain 128 (see for purposes of illustration the smart contract deployed on Mainnet Ethereum at 0xA8A6CB3978e2c4EdcF5A3d0cB3400E1E5D031479). The following acts (as well as any other acts described in any other methods in this disclosure) may occur in any order:

At act 640, the NFT viewer uses computer 618 and web3 enabled browser 619 to request an NFT corresponding to an edition of a project from the Art smart contract 604 and associated logs 606.

At act 642, the NFT viewer receives the logs from the smart contract 604 logs 606 that provides the projectId and transaction hash associated with the minted token. Alternatively, the NFT viewer may request the hash from the smart contract 604 associated with the tokenId if the smart contract stores that information in contract storage. At act 642, or at another time, the NFT viewer may query the contract for the projectId associated with the tokenId, as well as the associated script transaction hash.

At act 644, the NFT viewer uses web3 enabled browser 619 to request the code associated with the projectId from smart contract 600 and logs 602. To do this, the web3 enabled borowser may use the script transaction hash.

At act 646, the NFT viewer's computer 618 and web3 browser 619 can use the generative art script along with the minting transaction hash to generate and render the edition of the art and compute metadata associated with that NFT.

With reference to FIG. 6D, an example system and method for a metadata server to provide support for legacy marketplaces is illustrated. A Page/Post smart contract 600 is deployed on the Ethereum blockchain 128 (see for purposes of illustration the smart contract deployed on Mainnet Ethereum at 0x499f4943fB86717adcE584927E6AB5a172f03001). An Art Project smart contract 604 is also deployed on the Ethereum blockchain 128 (see for purposes of illustration the smart contract deployed on Mainnet Ethereum at 0xA8A6CB3978e2c4EdcF5A3d0cB3400E1E5D031479). A metadata server 654 with JSON server and file storage 658 is made available.

At act 650, an NFT owner/viewer/marketplace/etc. 241 that is monitoring the blockchain for new NFTs detects that a new token was issued for smart contract 604. Entity 241 requests the token URI to get a URL to the optional metadata server 652 for the requested tokenId. At act 652, the entity 241 requests the NFT corresponding to the tokenId from the metadata server 654. At act 240, software 658 running on server 654 requests the NFT from the Ethereum blockchain via smart contract 602 and the smart contract logging system 606. At act 642, the logs are provided to the metadata server 654 and software 658. The logs may optionally be filtered based on any specified tokenId and/or project and edition information to retrieve only relevant transaction hash for the desired NFT content. At act 644, the software 658 retrieves the appropriate generative art code using the script transaction hash associated with the project of the tokenId. At act 660, the software 658 prepares a response including metadata and image data formatted as expected by entity 241 (for example as JSON Object including metadata and image data or references). At act 662, entity 241 receives the formatted data from the server 654 and software 658. Entity 241 may store the data contained in response 662 in their system to facilitate queries from third parties. At act 664, an NFT consumer using a computer 618 and web3 enabled browser 619 requests the NFT from the entity 241. At act 666, entity 241 responds with a webpage containing information previously retrieved and stored regarding the particular NFT.

III.B. Example Implementation of a Generative Art Platform Building on Modular Code Blocks Published Using the Content Publishing System.

A generative art platform, or other application such as a game, may build on the Page and Post content building blocks. For example, a generative artists can create an Page NFT including a Post with p5j s compatible source code and other content items such as example image thumbnails, and information about the generative art series. The artists own this code by way of the Page NFT.

The generative art platform user interface may be a React app that is hosted via IPFS and that runs entirely on the client computer with the smart contract on a blockchain providing back-end logic and storage.

The artist can then create an Art project that references the code Post by its transaction hash from the NFT Page. The Art project front end or contract may verify that the author of the code Post transaction is the same as the Art project creator/owner to ensure that there is no counterfeiting. Similarly, the Art project contract or front end may verify that the Page name of the code Post matches the Art project name.

For a selected generative art project, the Art front-end may import the code from the associated code Post transaction. It can then use this code to allow editions of the generative art series to be minted, and then render the artworks live using the p5j s code obtained from the Post via the blockchain.

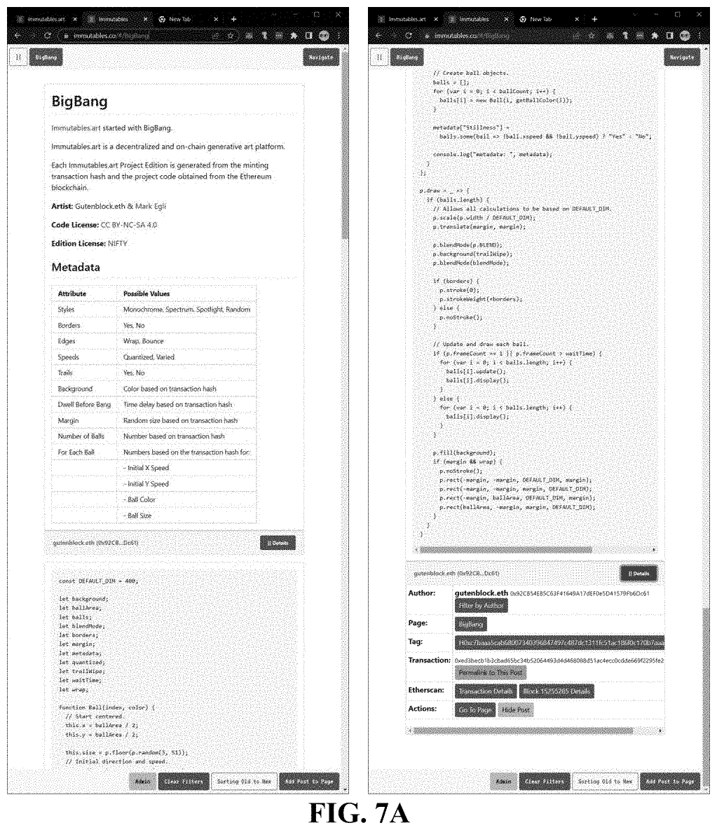

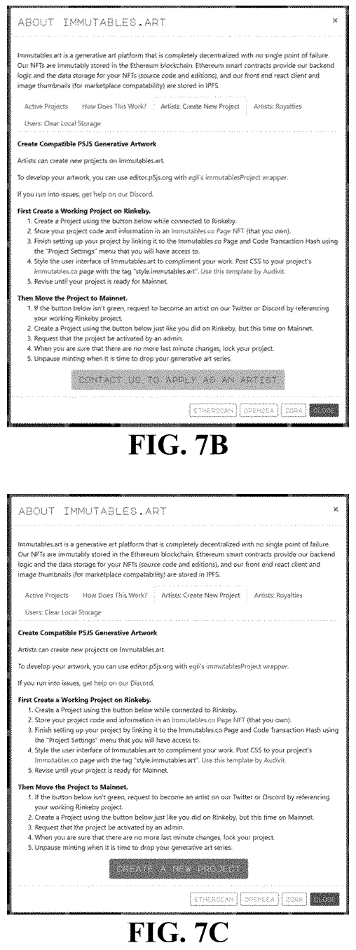

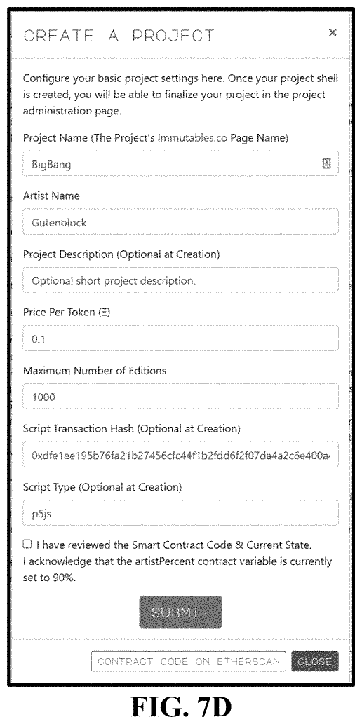

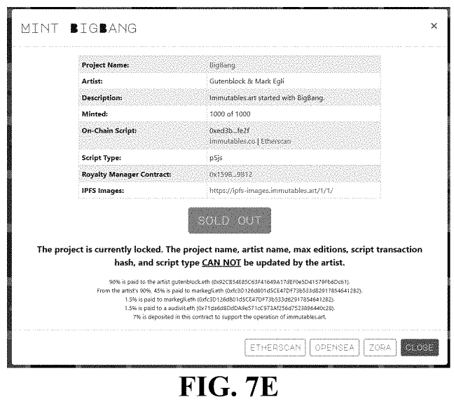

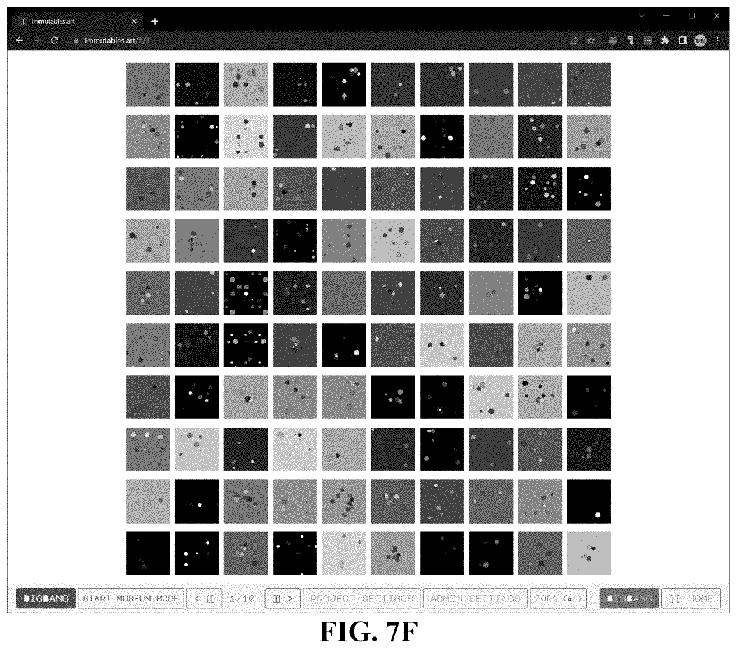

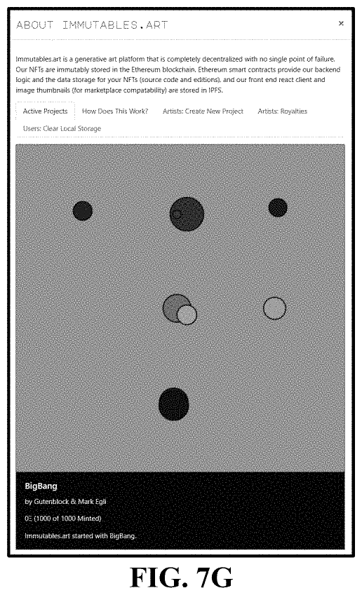

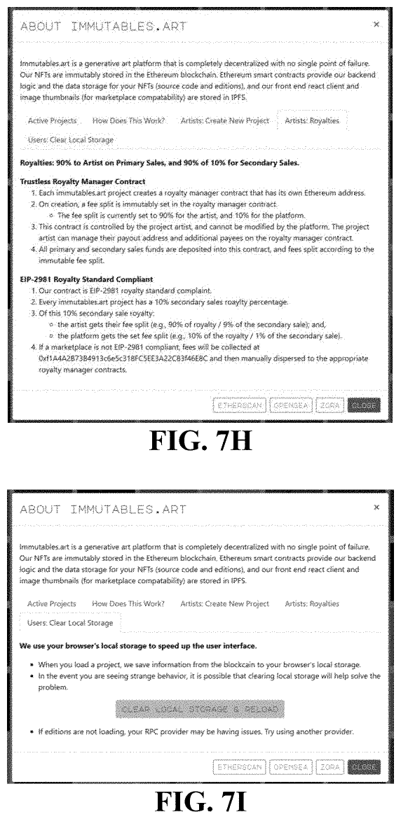

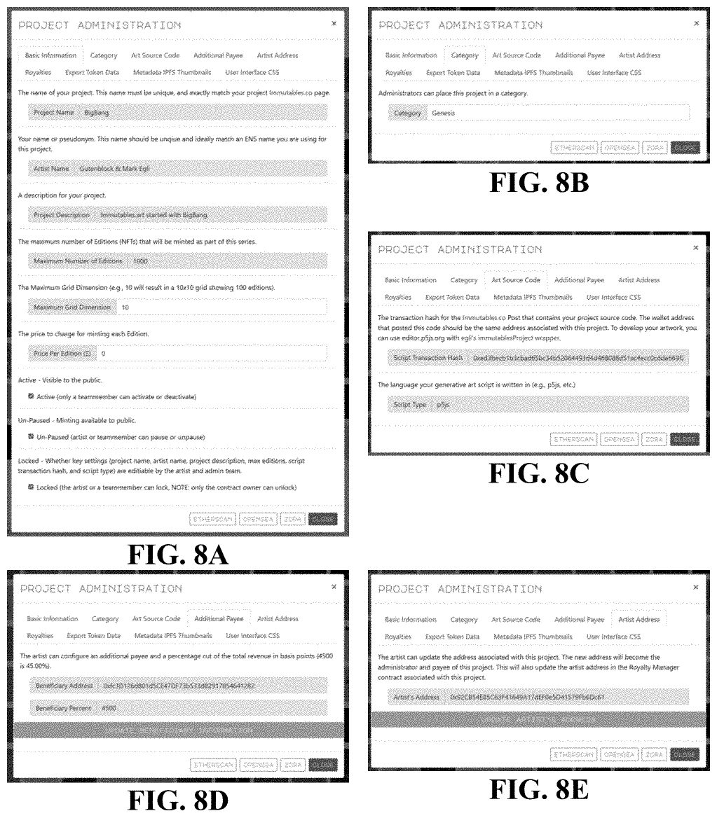

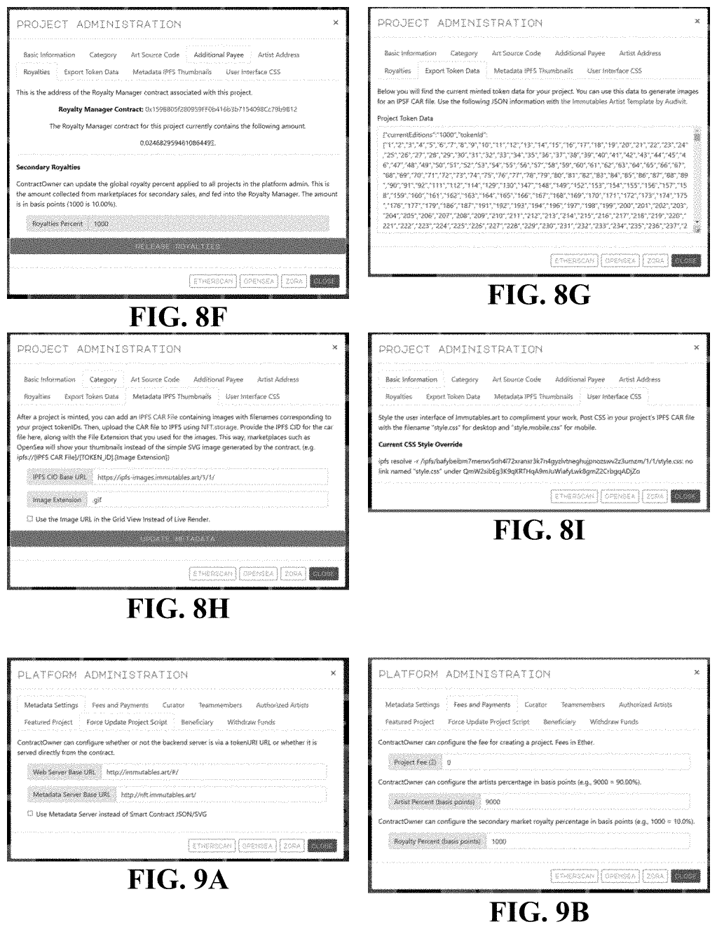

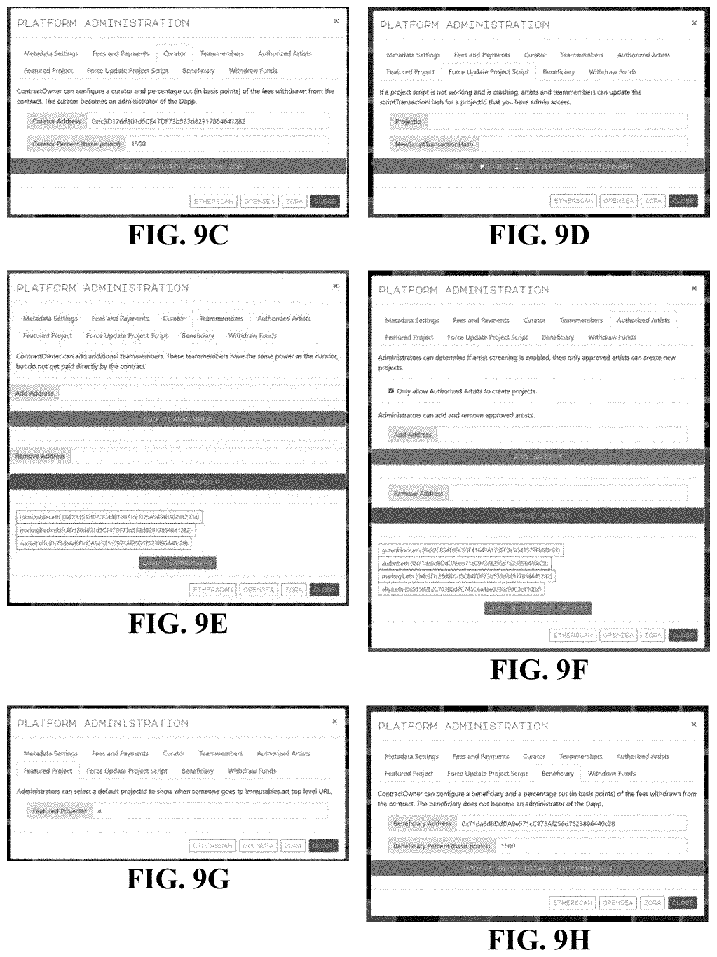

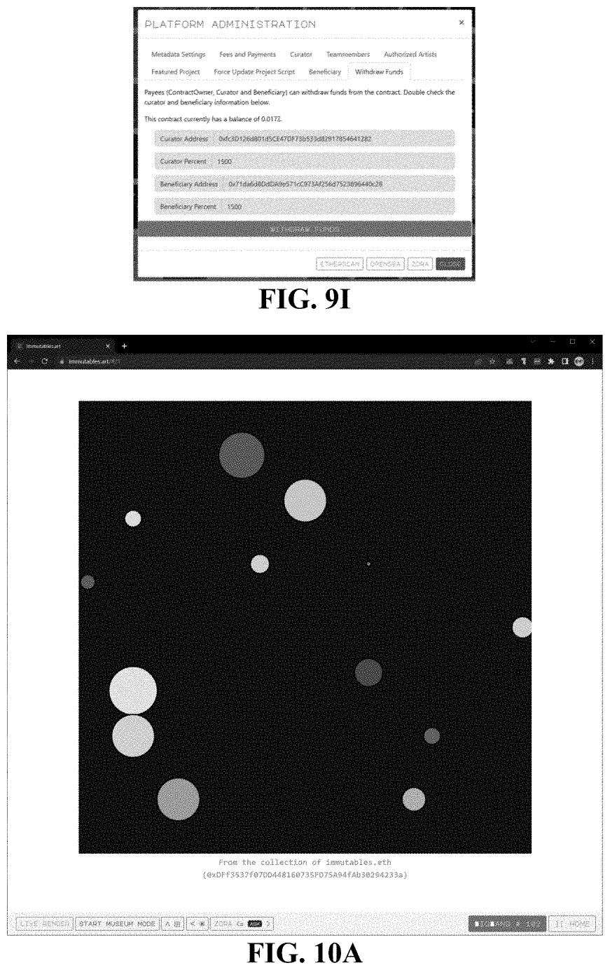

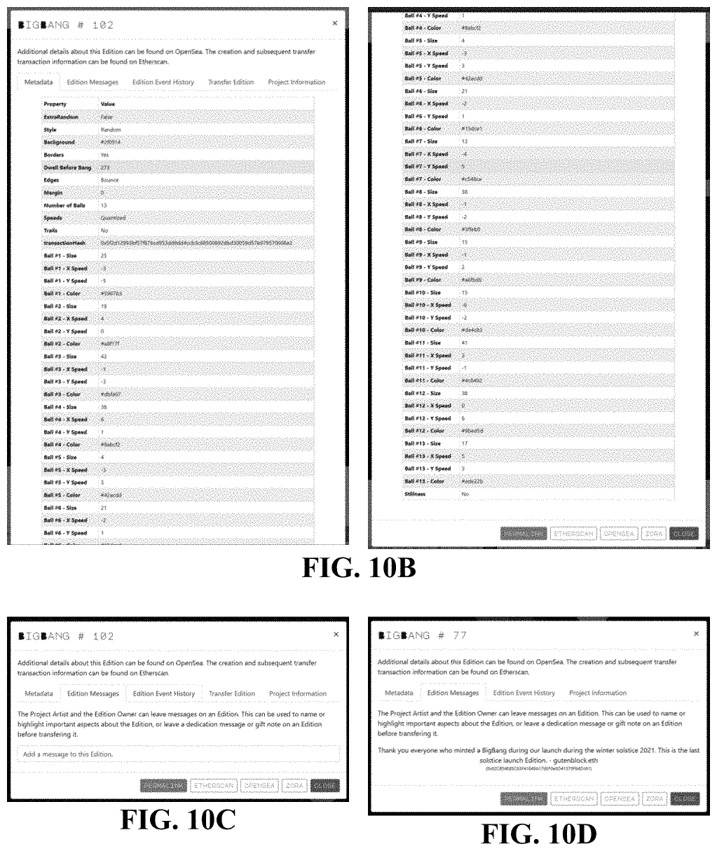

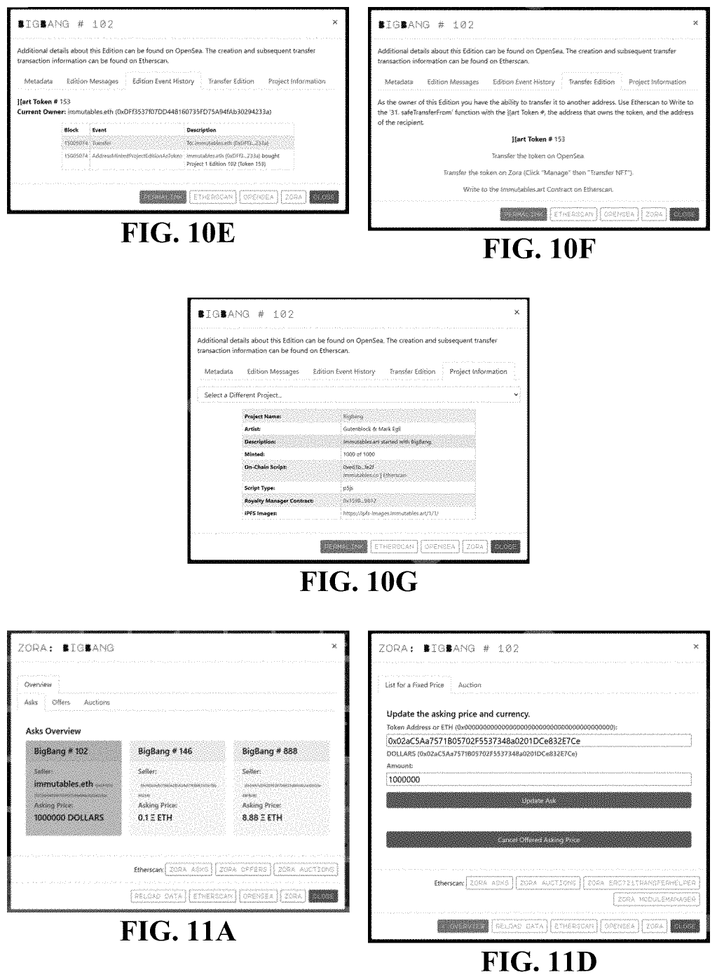

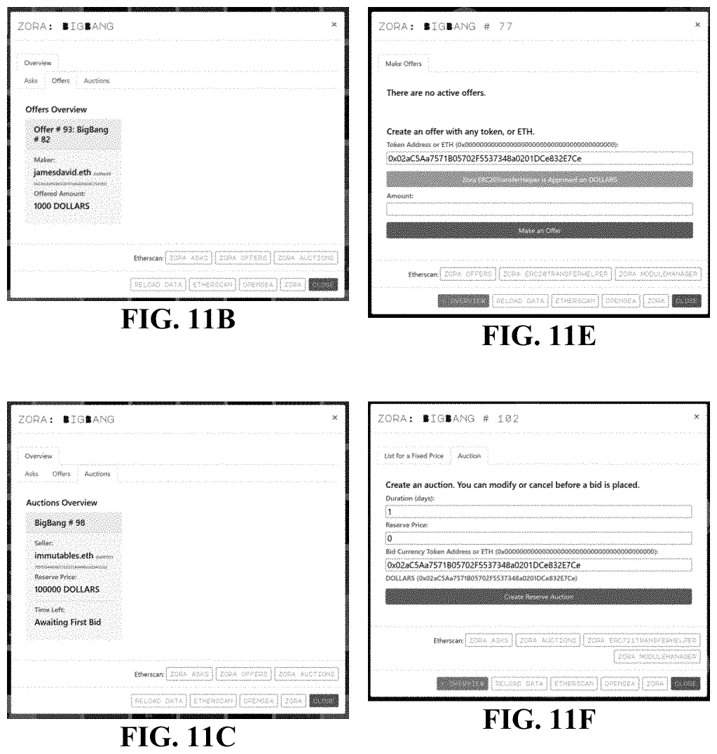

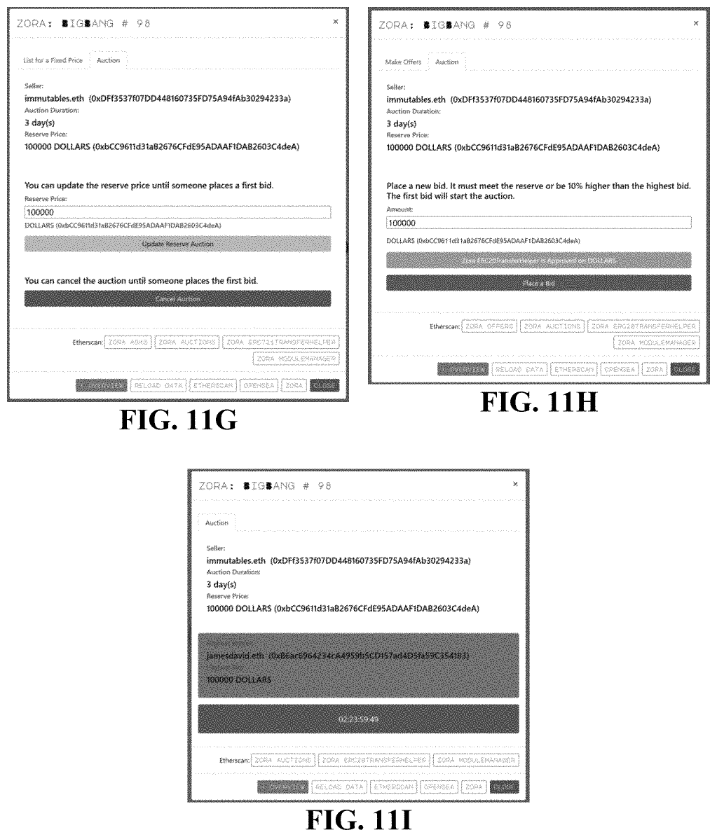

With reference to FIG. 7A, an example user interface showing a Page with generative art project information in one Post, and generative art code in a second Post is illustrated. Specifically, the Page is titled “BigBang”. A first Post contains information about the generative art project and lists the author on the bottom of the post as “gutenblock.eth”. A second Post contains generative art code written in the p5js format. A “] [ Details” button on the second post has been pressed to expand an details table about that particular post. The details include the Author of the Post and the author's public key, the Page associated with the Post, a Tag associated with the Post (note the Tag includes a command H[Tx] to hide a prior transaction from the view on the Page), the Transaction Hash for the displayed post, links to additional information, and links to perform Actions relating to the post.

With reference to FIG. 7B, an example user interface showing information about creating a project on the generative art platform when the viewer does not have permission to create a project is illustrated. A “contact us to apply as an artist” button is displayed when the viewer of the signup form does not have permission on the smart contract 604 to create a project.

With reference to FIG. 7C, an example user interface showing information about creating a project on the generative art platform when the viewer does have permission to create a project is illustrated. A “create a new project” button is displayed when the viewer of the signup form has permission on the smart contract 604 to create a project.

With reference to FIG. 7D, an example user interface showing the create a project form is illustrated. The create a project form is launched by the “create a new project” button shown in FIG. 7C and allows an authorized artist to create a new project within smart contract 604. For example, the author of the Post shown in FIG. 7A may create a project referencing the Transaction hash shown on the second post of FIG. 7A as the “Script Transaction Hash” in this form.

With reference to FIG. 7E, an example user interface to mint an edition of a project is illustrated. The user interface may include a table showing information including the Project name, Artist name, Description of the project, number of edition minted of the total number of editions allowed, the associated on-chain generative art script, the language of the associated script, an associated royalty manager contract, and a link to IPFS images of associated editions that the contract may serve directly to legacy marketplaces instead of simple SVG images. A button allowing minting by authorized parties, or the general public may be made available. If all editions have been created, the button may indicate “Sold Out” or similar. Information about the ability to modify the project as well as the royalty payments relating to the project may also be show.

With reference to FIG. 7F, an example user interface showing an overview grid view of many editions of a generative art project is illustrated. A menu bar may include the button to mint editions of the project (“BigBang”), a button to “Start Museum Mode” to show random editions of the project in detail view, a “Prior Grid” button, a current of total grid indication, a “Next Grid” button, a “Project Settings” menu button for those authorized to administer the generative art project, an “Admin Settings” menu button for those authorized to modify aspects of the platform, a “ZORA” marketplace button, a Project/Edition details button, and a Platform Information Button “] [ HOME”.

With reference to FIG. 7G, an example user interface showing an active projects tab of a platform information menu is illustrated.

With reference to FIG. 7H, an example user interface showing an artist's royalty information tab of a platform information menu is illustrated.

With reference to FIG. 3I, an example user interface showing users information about clearing their local storage browser cache, used to store information from the blockchain, is illustrated.

With reference to FIG. 8A, an example user interface showing the basic information tab of a project administration form is illustrated.

With reference to FIG. 8B, an example user interface showing the project category tab of a project administration form is illustrated.

With reference to FIG. 8C, an example user interface showing a source code tab of a project administration form is illustrated.

With reference to FIG. 8D, an example user interface showing an additional payee tab of a project administration form is illustrated.

With reference to FIG. 8E, an example user interface showing an artist address tab of a project administration form is illustrated.

With reference to FIG. 8F, an example user interface showing a royalties tab of a project administration form is illustrated.

With reference to FIG. 8G, an example user interface showing a token data export tab of a project administration form is illustrated.

With reference to FIG. 8H, an example user interface showing a metadata IPFS Thumbnails tab of a project administration form is illustrated.

With reference to FIG. 8I, an example user interface showing a User Interface CSS override tab of a project administration form is illustrated.

With reference to FIG. 9A, an example user interface showing a metadata settings tab of a platform administration form is illustrated.

With reference to FIG. 9B, an example user interface showing a fees and payments tab of a platform administration form is illustrated.

With reference to FIG. 9C, an example user interface showing a curator tab of a platform administration form is illustrated.

With reference to FIG. 9D, an example user interface showing force update project script tab of a platform administration form is illustrated.

With reference to FIG. 9E, an example user interface showing a team members tab of a platform administration form is illustrated.

With reference to FIG. 9F, an example user interface showing an authorized artists tab of a platform administration form is illustrated.

With reference to FIG. 9G, an example user interface showing a featured project tab of a platform administration form is illustrated.

With reference to FIG. 9H, an example user interface showing a beneficiary tab of a platform administration form is illustrated.

With reference to FIG. 9I, an example user interface showing a withdraw tab of a platform administration form is illustrated.

With reference to FIG. 10A, an example user interface showing a detail view of an edition of a generative art project is illustrated. A menu bar may include the button to toggle between a live render and a thumbnail image stored on IPFS (“Live Render” or “IPFS”), a button to “Start Museum Mode” to show random editions of the project in detail view or alternatively “Stop Museum Mode”, an “Up to Grid” button to return to the project overview grid, a “Prior Edition” button, a “Next Edition” button, a “Project Settings” menu button for those authorized to administer the generative art project, an “Admin Settings” menu button for those authorized to modify aspects of the platform, a “ZORA” marketplace button that also may include an indication if there is an “Ask” “Offer” or “Auction” available on the selected edition, a Project/Edition details button (“BigBang #102”), and a Platform Information Button “] [ HOME”.

With reference to FIG. 10B, an example user interface showing a metadata information readout tab of a project edition details form is illustrated.

With reference to FIG. 10C, an example user interface showing an edition messages tab of a project edition details form is illustrated.

With reference to FIG. 10D, an example user interface showing an edition messages tab of a project edition details form that includes a message associated with the token is illustrated.

With reference to FIG. 10E, an example user interface showing an edition event history tab of a project edition details form is illustrated.

With reference to FIG. 10F, an example user interface showing a transfer edition tab of a project edition details form is illustrated.

With reference to FIG. 10G, an example user interface showing a project information tab of a project edition details form is illustrated.

With reference to FIG. 11A, an example user interface showing an asks tab of a marketplace overview is illustrated.

With reference to FIG. 11B, an example user interface showing an offers tab of a marketplace overview is illustrated.

With reference to FIG. 11C, an example user interface showing an auctions tab of a marketplace overview is illustrated.

With reference to FIG. 11D, an example user interface showing a list for a specified price tab for a marketplace form associated with a project and edition shown to the owner is illustrated.

With reference to FIG. 11E, an example user interface showing a make offer tab a for a marketplace form associated with a project and edition shown to a third-party is illustrated.

With reference to FIG. 11F, an example user interface showing a create auction tab for a marketplace form associated with a project and edition shown to the owner is illustrated.

With reference to FIG. 11G, an example user interface showing auction tab for a marketplace form associated with a project and edition shown to the owner after creating an auction, but before the first bid, is illustrated.

With reference to FIG. 11H, an example user interface showing an auction tab a for a marketplace form associated with a project and edition shown to a third-party that is not the high bid is illustrated.

With reference to FIG. 11I, an example user interface showing an auction tab for a marketplace form associated with a project and edition shown to the current high bidder is illustrated.

III.C. Third-Party Composability. Third-party developers can utilize the composability of the Page and Art smart contracts, and the data that is available on the blockchain log storage, to create other front-end applications that build on the data; everything is on-chain. For example, a rarity guide tool can be created that pulls the project information from the ImmutablesArt smart contract 604 and logs 606, and the code transactions from the Immutables contract 600 and logs 602 on the blockchain for each project. It may then use this data to calculate and verify the metadata from the code to produce a rarity ranking for each project and edition.

IV. Front-End User Interfaces.

The front end user-interfaces can be any type of computer application, but in the examples provided herein the user interfaces are stored as React applications on IPFS.

V. Conclusion.

As those skilled in the art will appreciate, many aspects of the invention, and the various forms of the invention, can beneficially be practiced alone and need not be coupled together. Unless specifically stated otherwise, no aspect of the invention should be construed as requiring combination with another aspect of the invention in practice. However, those skilled in the art will also appreciate that the aspects of the invention may be combined in any way imaginable to yield one of the various forms of this invention.

Various alterations and changes can be made to the above-described embodiments without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

I claim:

1. A method of storing information in a blockchain associated with a non-fungible token, comprising:
a) submitting a first transaction to a first smart contract on a blockchain to mint a Page as an non-fungible token;
b) submitting a second transaction to the first smart contract on the blockchain to insert an item of content into a Page as a Post, wherein the Post is logged as an event in the blockchain.

2. The method of claim 1, wherein the item of content is a block of executable computer code.

3. The method of claim 2, further comprising:
a) submitting a third transaction to a second smart contract on the blockchain to create a project that is associated with a transaction hash associated with the second transaction.
